(19) United States
(12) Patent Application Publication
(10) Pub. No.: US 2026/0273730 A1
(43) Pub. Date: Sep. 17, 2026

(54) SYSTEM

(71) Applicant: SoftBank Group Corp., Tokyo (JP)

(72) Inventor: Wataru NAGAMURA, Tokyo (JP)

(73) Assignee: SoftBank Group Corp., Tokyo (JP)

(21) Appl. No.: 19/551,628

(22) Filed: Feb. 27, 2026

Related U.S. Application Data
(60) Provisional application No. 63/769,958, filed on Mar. 11, 2025.

(51) Int. Cl. B25J 9/16; G06F 40/211; G06F 40/268; G06F 40/279; G06F 40/30; G06F 40/40; G06V 40/16; G09B 5/06; G10L 25/63

(52) U.S. Cl. CPC B25J 9/161; B25J 9/1633; B25J 9/1697; G06F 40/211; G06F 40/268; G06F 40/279; G06F 40/30; G06F 40/40; G06V 40/171; G06V 40/174; G09B 5/06; G10L 25/63

(57) ABSTRACT

A system includes a processor that is configured to control a camera unit that captures an image of a printed user manual, control an optical character recognition unit that converts character information included in the captured image of the user manual into digital data, control a natural language processing unit that analyzes the digital data and extracts important information from the digital data, control a generative artificial intelligence unit that summarizes procedures described in the user manual based on the extracted important information, control a robot arm unit that operates an automated hand based on the summarized procedures, and control a control unit that controls operation of the robot arm unit.

### CROSS-REFERENCE TO RELATED APPLICATION

This application claims the benefit of U.S. Provisional Application No. 63/769,958, filed on Mar. 11, 2025, pursuant to 35 U.S.C. § 119(e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for assisting users in assembling or repairing products based on printed user manuals impose several burdens on users and on service providers. A user generally needs to manually read and interpret complex printed manuals, which often include dense text, technical terminology, and multi-step procedures that are difficult to follow, especially for inexperienced users. Even when digital versions of manuals are available, known systems typically present the same unprocessed text without automatically extracting important information, summarizing procedures, or adapting the level of detail to the user's skill level. Furthermore, conventional systems do not tightly integrate natural language understanding of manuals with automatic physical execution by a robot arm. As a result, users must manually translate textual instructions into concrete physical actions, which increases the time required and the likelihood of mistakes. In addition, known robotic systems used in industrial or service environments generally require pre-programmed operation sequences and do not automatically derive robot actions from arbitrary printed manuals. Therefore, there is a need for a system capable of capturing a printed user manual, automatically converting its contents into digital text, analyzing and summarizing important procedures using natural language processing and generative artificial intelligence, and then controlling a robot arm to carry out the summarized procedures, thereby reducing the burden on the user and improving work efficiency and accuracy.

### SUMMARY

In order to solve the above-described problems, according to one aspect of the present invention, there is provided a system comprising a processor, wherein the processor is configured to control a camera unit that captures an image of a printed user manual, control an optical character recognition unit that converts character information included in the captured image of the user manual into digital data, control a natural language processing unit that analyzes the digital data and extracts important information from the digital data, control a generative artificial intelligence unit that summarizes procedures described in the user manual based on the extracted important information, control a robot arm unit that operates an automated hand based on the summarized procedures, and control a control unit that controls operation of the robot arm unit. In one embodiment, the processor is configured to control the camera unit such that the camera unit captures the image of the printed user manual at a high resolution, control the optical character recognition unit such that the optical character recognition unit accurately converts character information included in the printed user manual into the digital data, control the natural language processing unit such that the natural language processing unit understands a structure of sentences in the digital data and extracts the important information based on the structure of the sentences, and control the generative artificial intelligence unit such that the generative artificial intelligence unit extracts particularly important procedures and cautions from the user manual and summarizes the particularly important procedures and cautions in a concise step-by-step format. In another embodiment, the processor is configured to control the robot arm unit such that the robot arm unit has a plurality of joints and is operable to move freely in a manner similar to a human hand, to control the robot arm unit such that the robot arm unit uses one or more cameras and tactile sensors mounted on the robot arm unit to grasp in real time a shape and a position of a product, to control the robot arm unit such that the robot arm unit operates in accordance with the procedures summarized by the generative artificial intelligence unit, to control the robot arm unit such that the robot arm unit accurately grasps a screw and tightens the screw with an appropriate torque, and to control the robot arm unit such that, when assembling parts, the robot arm unit uses sensor information to perform fine adjustment in order to accurately align positions of the parts with respect to each other. By these means, the system automatically converts a printed user manual into structured, summarized procedures and executes the procedures by a robot arm, thereby reducing the user's cognitive load, shortening operation time, and improving accuracy and safety of assembly and repair tasks.

The term “processor” refers to one or more hardware processing circuits, such as a central processing unit (CPU), a microcontroller, a digital signal processor (DSP), or any combination thereof, that execute programs or control logic to perform the functions described in the claims.

The term “camera unit” refers to a hardware component including at least one image sensor and associated optics, configured to capture an image of a printed user manual and output image data representing the printed user manual.

The term “printed user manual” refers to a physical document, such as a paper instruction manual, leaflet, or booklet, that includes printed character information and optionally diagrams or figures describing assembly, operation, or repair procedures for a product.

The term “optical character recognition unit” refers to a hardware and/or software component configured to receive image data from the camera unit and to convert character information included in the image data into digital data representing text.

The term “digital data” refers to electronically stored or processed information representing the contents of the printed user manual, including at least text obtained by optical character recognition, and optionally structured elements such as headings, lists, and step identifiers.

The term “natural language processing unit” refers to a hardware and/or software component configured to analyze the digital data representing text in a natural language, to understand a structure of sentences and documents, and to extract important information such as procedures, cautions, parts, and tools from the digital data.

The term “important information” refers to information extracted from the digital data that is relevant to performing an assembly, operation, or repair procedure, including at least procedural steps, cautions or warnings, required parts, and required tools.

The term “generative artificial intelligence unit” refers to a hardware and/or software component, including a trained machine learning or neural network model, configured to generate new text or other content based on input data, and to summarize procedures described in the digital data into user-oriented instructions.

The term “summarized procedures” refers to instructions generated by the generative artificial intelligence unit that represent procedures described in the printed user manual in a condensed, reorganized, or step-by-step format tailored for user comprehension or for control of the robot arm unit.

The term “robot arm unit” refers to a robotic manipulator including a plurality of joints and links, and optionally one or more end effectors, that is configured to perform physical operations such as grasping parts, moving parts, and tightening screws based on control commands.

The term “automated hand” refers to an end effector or gripper provided at a distal end of the robot arm unit and configured to perform operations similar to a human hand, including grasping, holding, manipulating, or releasing parts or tools.

The term “control unit” refers to a hardware and/or software component that generates and outputs control signals to the robot arm unit, including signals for joint motions, speed, torque, and safety functions, based on the summarized procedures and sensor feedback.

The term “high resolution” refers to a capability of the camera unit to capture images with a number of pixels and image quality sufficient for the optical character recognition unit to accurately recognize characters contained in the printed user manual.

The term “structure of sentences” refers to grammatical and logical relationships within the text of the digital data, including at least sentence boundaries, parts of speech, dependencies, and discourse-level organization such as sections and lists.

The term “particularly important procedures and cautions” refers to those procedures and warnings that are identified as critical for successful and safe completion of the tasks described in the printed user manual, including steps whose omission or incorrect execution may cause malfunction, damage, or safety hazards.

The term “concise step-by-step format” refers to a representation of the summarized procedures as an ordered list of discrete steps, each expressed in relatively short, clear sentences that guide the user or the robot arm unit through the tasks in sequence.

The term “plurality of joints” refers to two or more rotational or translational joints in the robot arm unit that enable multi-degree-of-freedom movement of the robot arm unit.

The term “tactile sensors” refers to sensors mounted on the robot arm unit or on the automated hand that detect physical contact, force, pressure, or similar quantities, and provide feedback for controlling grasping and alignment of parts.

The term “shape and position of a product” refers to geometric characteristics and spatial location of a target product or parts thereof, as estimated or measured by the robot arm unit using one or more cameras and tactile sensors.

The term “appropriate torque” refers to a torque value or range predetermined or selected for tightening a screw such that the screw is sufficiently tightened without overtightening or damaging associated parts.

The term “fine adjustment” refers to small corrective movements or force adjustments performed by the robot arm unit based on sensor information in order to precisely align or position parts relative to each other during assembly.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

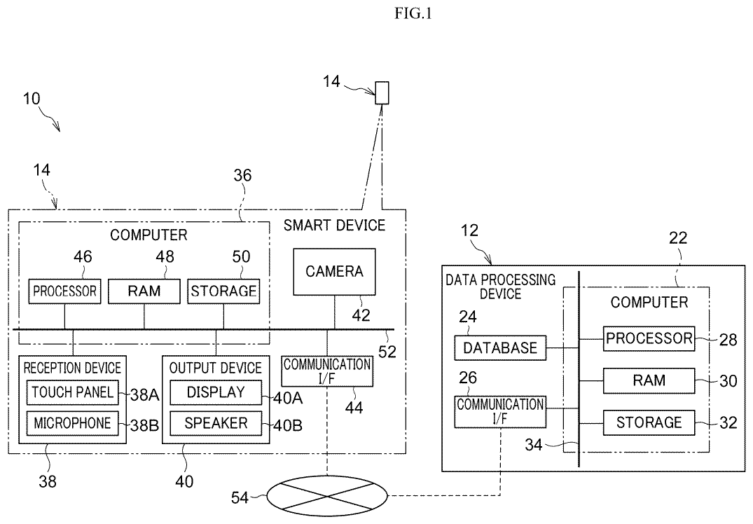

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

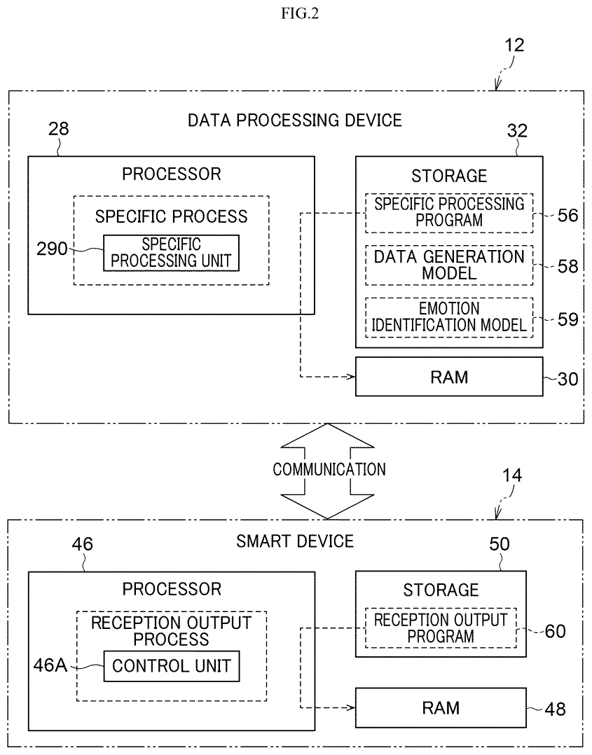

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional techniques for assisting a user in executing procedures described in paper manuals, such as assembly instructions or maintenance guides, typically rely on static digitization and simple rule-based processing. In many systems, an imaging device captures an image of a manual, an optical character recognition engine converts the image into text, and a display device presents the recognized text or a fixed-format summary to the user. However, such systems merely transfer the manual from paper to a screen, without substantially improving how a computing system internally represents, reasons over, or operationalizes the procedural information.

As a result, several technical problems arise in the field of computer technology. First, a processor cannot easily distinguish between procedure steps, warnings, tool requirements, and contextual notes in the raw text, so that the internal data structures remain unstructured or weakly structured. This hinders subsequent automated processing, including machine reasoning, dynamic reformatting, or execution by robotic devices. Second, generic text summarization or template-based formatting does not adapt to user-specific context such as skill level, language proficiency, or desired granularity, leading to either excessive cognitive load for novice users or inefficient over-explanation for expert users. Third, when a robotic mechanism is used to physically execute portions of a procedure, existing systems lack a robust computational pipeline that converts natural language instructions into machine-interpretable, step-wise control data, such as low-level joint commands and force profiles, while maintaining safety and traceability.

Furthermore, conventional uses of generative models often treat large language models as opaque text generators, without integrating them into a structured pipeline that enforces explicit constraints, preserves critical safety information, or feeds into downstream motion planning. Prompt sentences are often ad hoc and not derived from an internally consistent representation of the manual. Consequently, generative models may omit warnings, alter procedural order, or produce text that cannot be deterministically mapped to executable control sequences for robotic mechanisms. This leads to unreliable or unsafe behavior when attempting to automate physical tasks based on generated instructions.

Additionally, many systems fail to exploit sensor feedback in a closed-loop computational architecture that ties together recognized manual content, generated step representations, and real-time control of a multi-joint work mechanism. Without a unified data model linking textual procedures to sensor data, a processor cannot reliably detect deviations between intended motions and actual measured states, nor can it systematically update generated procedure data in response to user feedback or execution outcomes. This limits the capacity of the computing system to self-correct, learn from prior sessions, and optimize future prompt construction and generative behavior.

Accordingly, there is a need for an improved computer-based system and method that: (i) converts unstructured manual text into a rich, structured representation distinguishing procedure steps, warnings, tool requirements, and notes; (ii) algorithmically constructs explicit prompt sentences for a generative AI model based on this structured data and user context; (iii) generates machine-interpretable procedure data that can be directly used for both adaptive user presentation and robotic execution; and (iv) integrates sensor feedback and abnormality detection into a closed-loop control architecture, thereby improving the reliability, safety, and computational efficiency of end-to-end manual understanding and robotic assistance.

The specific processing by the specific processing unit 290 of the data processing device 12 in Example 1 is realized by the following means.

The present invention provides a server comprising a processor configured to acquire, from a user-operated image capturing device, image information including description information recorded on an information recording medium, perform preprocessing on the image information, and execute optical character recognition processing on the preprocessed image information so as to extract character information and convert the character information into machine-readable character string data; execute natural language processing on the character string data to segment the character string data into units of sentences and words, perform syntactic analysis and semantic analysis on the segmented data, automatically classify each sentence into at least one of a procedure category, a warning category, a tool requirement category, and a note category, perform term conversion processing that converts technical terms into generic expressions, and generate structured data representing task procedure information, caution information, component information, and tool information; generate a prompt sentence for input to a generative information processing model on the basis of the structured data and context information including user attribute information, include in the prompt sentence constraint conditions that explicitly specify an output format, a detail level, a language level, and a display style for warning information, execute the generative information processing model using the prompt sentence and the structured data as inputs, and generate procedure data in which a task procedure is summarized as a sequence of steps and which includes, for each step, warning information and illustration metadata; identify, on the basis of the procedure data, steps that are executable by an automated multi-joint work mechanism, associate each identified step with at least one operation template selected from a transport operation template for grasping and conveying a component, a fastening operation template for fastening a fastening member with a predetermined torque, and an alignment operation template for positioning components relative to each other, and generate a low-level operation sequence including grasping operations, positioning operations, and fastening operations in accordance with an association result; perform kinematic calculation and trajectory planning calculation on the low-level operation sequence so as to generate, in time order, joint command values, position command values, and force command values for the multi-joint work mechanism, and transmit the joint command values, the position command values, and the force command values to the multi-joint work mechanism so as to control the multi-joint work mechanism; acquire position detection information, force detection information, and image detection information from the multi-joint work mechanism, generate correction commands on the basis of deviations between the position detection information and at least one of the joint command values and the position command values, correct, in real time, parameters of the operation template on the basis of the image detection information and the force detection information, and stop an operation of the multi-joint work mechanism when an abnormal state is detected; generate presentation data for transmission to a user terminal, the presentation data being configured to cause the user terminal to perform visual presentation of the procedure data in a step-by-step format and to perform audio guidance based on the procedure data; and generate and transmit an additional prompt sentence to the generative information processing model so as to regenerate and update at least a part of the procedure data in response to a user request for increasing or decreasing a level of detail, and update the presentation data on the basis of regenerated procedure data. This enables improvement of the functioning of the computer system by providing an end-to-end computational architecture in which unstructured manual images are transformed into structured, semantically labeled data, explicit prompt sentences are algorithmically constructed for a generative AI model, generated procedure data is constrained and rendered machine-interpretable for both adaptive user presentation and robotic execution, and sensor feedback from a multi-joint work mechanism is integrated into closed-loop control, thereby enhancing reliability, safety, and efficiency of computer-implemented manual understanding and automated task execution.

The term “image information” refers to digital image data representing at least a portion of an information recording medium, the digital image data including pixels that visually encode description information such as text, symbols, or diagrams recorded on the medium.

The term “description information” refers to human-readable content recorded on an information recording medium, including but not limited to instructions, procedures, warnings, notes, component names, and tool indications.

The term “information recording medium” refers to any physical or electronic medium on which description information is recorded, including but not limited to paper documents, printed manuals, labels, and display screens.

The term “image capturing device” refers to a hardware device configured to acquire image information from an information recording medium, including but not limited to a camera integrated in a user terminal, a standalone digital camera, or a document scanner.

The term “optical character recognition processing” refers to processing that analyzes image information to detect and recognize character shapes and converts the detected characters into corresponding machine-readable textual data.

The term “machine-readable character string data” refers to textual data encoded in a digital format interpretable by a computing device, the textual data including one or more sequences of characters corresponding to the recognized description information.

The term “preprocessing” refers to operations performed on raw image information prior to optical character recognition processing, including but not limited to noise reduction, contrast adjustment, binarization, perspective correction, cropping, and resizing.

The term “natural language processing” refers to computational processing performed on character string data to analyze linguistic structure and meaning, including operations such as tokenization, sentence segmentation, syntactic analysis, semantic analysis, and text classification.

The term “syntactic analysis” refers to processing that determines grammatical relationships within character string data, including but not limited to part-of-speech tagging and parsing of sentence structure.

The term “semantic analysis” refers to processing that determines semantic roles, meanings, and relationships within character string data, including but not limited to identification of actions, entities, and their relationships in context.

The term “task procedure information” refers to information representing a sequence of actions or steps to be performed in order to complete a task described by the description information.

The term “caution information” refers to information indicating a warning, hazard, risk, or precaution associated with one or more steps of a task procedure.

The term “component information” refers to information identifying physical items or parts referenced in the description information, including but not limited to structural parts, modules, and assemblies.

The term “tool information” refers to information specifying instruments or devices required to perform one or more steps of a task procedure, including but not limited to hand tools, power tools, and measuring instruments.

The term “structured data” refers to data organized according to a predefined schema or format, in which task procedure information, caution information, component information, and tool information are represented as identifiable fields or entities that can be programmatically accessed and processed.

The term “user attribute information” refers to data that characterizes a user of the system, including but not limited to skill level, language preference, domain expertise, and preferred detail level.

The term “context information” refers to information used to condition processing by the system, including at least user attribute information and optionally additional data such as device capabilities, environmental conditions, or task type.

The term “generative information processing model” refers to a machine learning model configured to generate output data, such as natural language text or structured representations, in response to input data, the model including but not limited to a generative AI model such as a neural network-based language model.

The term “prompt sentence” refers to a sequence of one or more textual instructions, constraints, and contextual descriptions provided as input to a generative information processing model to specify a desired output format, content, and style.

The term “procedure data” refers to data generated by a generative information processing model representing a task procedure, the data including a sequence of steps and associated information such as warning information and illustration metadata.

The term “illustration metadata” refers to data describing visual content associated with a step of a task procedure, including but not limited to indications of parts, positions, orientations, or actions to be depicted in an image or diagram.

The term “sequence of steps” refers to an ordered collection of step entities, each step representing a discrete action or group of actions in a task procedure.

The term “automated multi-joint work mechanism” refers to a robotic mechanism having two or more joints and an end effector, configured to perform physical operations such as grasping, positioning, and fastening in accordance with control commands.

The term “step executable by an automated multi-joint work mechanism” refers to a step of a task procedure that can be at least partially performed by an automated multi-joint work mechanism under automated control, without requiring direct manual execution by a user.

The term “operation template” refers to a parameterizable representation of a class of robotic actions, including but not limited to grasping, transporting, fastening, and aligning operations, that can be instantiated into specific low-level commands based on parameters such as position, force, and timing.

The term “low-level operation sequence” refers to a time-ordered sequence of control-level actions or commands derived from one or more operation templates and configured to be executed by an automated multi-joint work mechanism.

The term “transport operation template” refers to an operation template specifying robotic behavior for grasping a component and conveying the component from a source location to a destination location.

The term “fastening operation template” refers to an operation template specifying robotic behavior for applying a fastening member, such as a screw or bolt, including at least rotation and force application with a predetermined torque or load profile.

The term “alignment operation template” refers to an operation template specifying robotic behavior for positioning one or more components relative to each other, including but not limited to orientation adjustment, contact alignment, and fine positioning.

The term “kinematic calculation” refers to computation for determining relationships between joint states and end-effector states of an automated multi-joint work mechanism, including but not limited to forward kinematics and inverse kinematics.

The term “trajectory planning calculation” refers to computation for generating time-parameterized motion trajectories, including joint command values, position command values, and velocity profiles, that satisfy constraints such as collision avoidance, joint limits, and motion smoothness.

The term “joint command values” refers to control values specifying desired joint states of an automated multi-joint work mechanism, including but not limited to joint positions, velocities, and accelerations.

The term “position command values” refers to control values specifying desired positions or poses of an end effector or component of an automated multi-joint work mechanism in a workspace coordinate system.

The term “force command values” refers to control values specifying desired force or torque to be applied by an automated multi-joint work mechanism, including but not limited to normal force, tangential force, and rotational torque.

The term “position detection information” refers to sensor data representing measured positions or joint states of an automated multi-joint work mechanism, including but not limited to joint encoder readings and end-effector position estimates.

The term “force detection information” refers to sensor data representing measured forces or torques applied by an automated multi-joint work mechanism, including but not limited to readings from force sensors or torque sensors.

The term “image detection information” refers to sensor data representing images or visual observations acquired by one or more imaging sensors associated with an automated multi-joint work mechanism or its environment.

The term “correction commands” refers to modified control commands generated on the basis of deviations between detection information and command values, the commands being configured to reduce such deviations and correct the motion or force of an automated multi-joint work mechanism.

The term “abnormal state” refers to a condition in which operation of an automated multi-joint work mechanism deviates from expected behavior, including but not limited to excessive force, unexpected obstruction, misalignment beyond a threshold, or sensor malfunction.

The term “user terminal” refers to an electronic device operated by a user, including but not limited to a smartphone, tablet computer, or personal computer, configured to communicate with a server and present information to the user.

The term “presentation data” refers to data generated for transmission to a user terminal and configured to cause the user terminal to present procedure data, including at least step-by-step visual information and optionally audio guidance information.

The term “audio guidance” refers to an auditory presentation of information related to a task procedure, including but not limited to spoken instructions, warnings, and confirmations synchronized with steps of the procedure.

The term “detail level” refers to a degree of granularity or completeness of information provided in procedure data, including the number of sub-steps, the amount of explanatory text, and the specificity of parameters.

The term “additional prompt sentence” refers to a prompt sentence generated after initial generation of procedure data, the prompt sentence being configured to request modification, refinement, expansion, or simplification of at least a part of the existing procedure data.

The term “regenerated procedure data” refers to updated procedure data produced by a generative information processing model in response to an additional prompt sentence, replacing or supplementing a corresponding portion of previously generated procedure data.

In one embodiment, a server, a terminal, and an automated multi-joint work mechanism cooperate to implement the claimed system. The server includes at least one processor and a memory storing program instructions. The terminal includes an image capturing device, a display, and a communication interface. The automated multi-joint work mechanism includes multiple joints, an end effector, and sensors such as position sensors, force sensors, and one or more cameras.

The terminal acquires image information by using a built-in camera that may be implemented by a smartphone camera module, a tablet camera module, or a dedicated document scanner.

The terminal uses an operating system camera framework, such as a general camera API analogous to a mobile camera framework, to control autofocus, exposure, and resolution parameters. The terminal stores the captured image information as digital image files, for example in JPEG or PNG format, in a non-transitory storage device.

The terminal preprocesses the image information by executing an image processing library, such as a library of the same type as OpenCV, on a terminal processor. The terminal converts color images to grayscale, applies noise reduction filters, performs contrast enhancement and binarization, and corrects perspective distortion by estimating document corner points and applying a projective transform. The terminal thereby reduces background artifacts and standardizes the layout of text regions, which increases the recognition rate of a subsequent optical character recognition engine and reduces the number of misrecognized characters, leading to improved downstream natural language processing accuracy.

The terminal executes optical character recognition processing by invoking an OCR engine such as an engine of the same type as Tesseract OCR, a mobile text recognition kit, or an OCR software development kit. The terminal passes preprocessed image buffers to the OCR engine and receives character string data together with information on bounding boxes and detected languages. The terminal converts the OCR output to a normalized machine-readable character encoding, for example UTF-8, and constructs an internal data structure that includes a sequence of lines, paragraph identifiers, page identifiers, and bounding box coordinates, stored in a structured text representation in memory.

The terminal transmits the structured OCR result to the server over a network using a protocol such as HTTPS. The terminal may further transmit user attribute information, such as a user-selected skill level (beginner, intermediate, expert), a preferred language, and a device capability profile. This user attribute information is stored in a user profile on the server and is later used to modulate prompt sentences and output detail levels.

The server receives the character string data and normalizes it by performing Unicode normalization, removal of redundant whitespace, and canonicalization of special symbols.

The server stores the normalized text in a persistent storage such as a relational database or a document database, together with metadata including timestamps, product identifiers, and user profile identifiers. The server represents the normalized text as a token sequence, where each token includes the original text, a token index, a sentence index, and positional information in the manual.

The server executes natural language processing using a language processing library, such as an off-the-shelf toolkit comparable to spaCy or a transformer-based model framework. The server segments the character string data into sentences and words using a tokenizer that is configured for at least one natural language. The server performs syntactic analysis by computing part-of-speech tags and dependency trees for each sentence. The server performs semantic analysis by detecting predicate-argument structures corresponding to actions (“tighten,” “attach,” “insert”), objects (parts, tools), and conditions (“if the indicator does not light,” “when the panel is aligned”).

The server classifies each sentence into categories such as procedure, warning, tool requirement, and note by executing a learned sequence labeling model. In one embodiment, the server uses a neural network architecture of the transformer type similar to a BERT-like encoder. The server encodes each token and its context into a contextual embedding vector and feeds the vectors into a classification head comprising one or more fully connected layers followed by a softmax output. The server trains the model in advance on labeled manual corpora using a cross-entropy loss function, backpropagation, and a gradient-based optimizer such as Adam. The server stores learned model parameters in non-volatile memory and loads them at runtime. As a result, the server can distinguish procedural sentences from warnings and metadata, producing a structured representation with improved classification accuracy compared to rule-based keyword methods, thereby reducing misclassification of critical warnings and enabling safer robotic execution.

The server performs term conversion processing by consulting one or more domain glossaries stored in a database. The server replaces specialist terms, such as part numbers or industry-specific jargon, with generic expressions or human-readable aliases when the user attribute information indicates a beginner. The server stores both the original term and the converted term as fields in a structured data object for later cross-referencing, which allows the system to maintain technical fidelity for expert users while simplifying outputs for beginners without losing traceability.

The server aggregates the results of classification, syntactic analysis, and semantic analysis into structured data. For each step candidate, the server generates a data record including at least: a step identifier, an action verb, an object or target, a list of associated parts, a list of required tools, a set of warnings, and references to the original text offsets. The server thus converts unstructured character string data into a machine-readable, graph-like or table-like representation that can be directly manipulated by algorithmic procedures and by a generative AI model.

The server constructs a prompt sentence for a generative AI model by combining (i) an instruction describing desired output format and constraints, (ii) the structured data derived from the manual, and (iii) context including user attribute information. The server may generate prompt sentences such as:

“Summarize the following instruction manual into clear, numbered steps for a beginner user. Keep all safety warnings and indicate them with the prefix ‘WARNING’. Provide short, simple sentences and include a brief description of what should be shown in an illustration for each step. The manual content is: [structured steps and warnings].”

“Adjust the following procedure for an expert technician. Keep torque values and alignment tolerances, but omit trivial explanations. Output a list of steps, each including: step number, short title, concise instruction, warnings, and required tools. The structured procedure is: [structured data].”

“Rewrite the following step for a non-technical user, preserving all technical accuracy but using simpler words and shorter sentences: [current step text].”

“Expand the following step into more detailed sub-steps, including specific tool positions and approximate timing, for an advanced user: [current step text].”

The server does not merely pass raw text to a generative AI model. Instead, the server algorithmically composes prompt sentences according to predefined templates and dynamically inserts constraint parameters (for example maximum step length, required warning prefixes, output schema) and user attribute information. This approach creates a deterministic mapping from internal structured data to prompt content, which in turn constrains the generative AI model output to a machine-interpretable format. This structured prompting improves computational reliability by reducing variance in output schema and simplifying downstream parsing and validation.

The server executes a generative information processing model that may be implemented as a large language model with a transformer architecture, comprising multiple attention layers, feedforward layers, and layer normalization modules. The server may deploy such a model using a framework analogous to a transformer library on a general purpose processor or a graphics processing unit. The server inputs the constructed prompt sentence and optionally a serialized representation of the structured data. The server sets model parameters such as a temperature value, a maximum token limit, and bias parameters for special tokens corresponding to step numbers and warning markers. The server obtains a generated output that contains a sequence of steps, each step including step number, instruction text, warnings, and illustration hints.

The server parses the generated output according to expected patterns. For instance, when the prompt requires a structured format, the server splits lines by step number prefixes and uses regular expressions or a shallow parser to extract fields. The server checks consistency by verifying that all warnings previously detected in the manual appear in the generated output, that step numbering is contiguous, and that required tools are not omitted. If inconsistencies or format violations are detected, the server may automatically regenerate the output by sending a refined prompt sentence that explicitly highlights the missing items. This feedback loop operates entirely within the computing system, improving the robustness of generative processing without user intervention.

The server maps the generated procedure data to operation templates for an automated multi-joint work mechanism. The server maintains a library of operation templates, each described by parameters such as target position variables, approach vectors, grip force thresholds, torque profiles, and timing constraints. For example, a “pick_and_place” template includes parameters for source location coordinates, destination coordinates, approach direction, grip closure force, and release timing. A “screw_tighten” template includes parameters for a screw axis orientation, pre-alignment motions, target torque, and maximum allowed torque rate. An “align_and_insert” template includes parameters for mating feature positions, allowable lateral misalignment, and insertion force profile.

The server analyzes each step in the procedure data to determine whether it corresponds to an operation template. The server uses a rule-based mapping that inspects action verbs and semantic roles (for example “tighten screw C,” “insert panel B into slot D,” “place part E on frame F”) and matches them to templates. When a match is found, the server creates an instance of the operation template by filling template parameters with values derived from a configuration database describing the physical workcell and from sensor calibration data. Because the mapping is driven by structured semantic roles rather than simple keyword search, the server generates more accurate and contextually correct control sequences, improving the success rate of automated execution.

The server performs kinematic calculation and trajectory planning for each instantiated operation template. The server executes a kinematics solver, such as one offered by a robotics toolbox comparable to a motion planning framework, to compute joint configurations that satisfy end-effector pose constraints. The server generates collision-free trajectories using a motion planning algorithm such as a sampling-based planner or an optimization-based planner, and then time-parameterizes the trajectories using velocity and acceleration constraints. The server thus produces joint command values and position command values that respect hardware limits, avoid obstacles in the workspace, and minimize unnecessary movement, thereby reducing wear on actuators and shortening cycle times.

The server computes force command values by specifying desired grip forces and torque targets based on information in the procedure data. For example, when the generated procedure specifies “tighten the screw until it is snug,” the server may reference a torque table in a database mapping screw sizes to recommended torque ranges, and set the target torque and maximum torque accordingly. The server transmits joint command values, position command values, and force command values to the multi-joint work mechanism controller over a communication link, using a protocol such as TCP/IP or a fieldbus protocol.

The multi-joint work mechanism executes the received commands and returns position detection information from joint encoders, force detection information from load cells or torque sensors, and image detection information from mounted cameras. The server processes this sensor feedback in a closed-loop control algorithm. The server compares measured positions to commanded positions and uses a control law, such as a proportional-integral-derivative (PID) controller or a model predictive control algorithm, to compute correction commands that reduce position and force errors. The server may further process image detection information using an image processing library to detect features such as hole centers, screw heads, or part edges, and adjust alignment motions if misalignment exceeds a threshold. This closed-loop integration of textual procedure data, generated step representations, and real-time sensor feedback yields a concrete improvement in control precision and error recovery over systems that merely replay pre-recorded trajectories without reference to manual content.

The server detects abnormal states by monitoring whether force detection information exceeds predefined safety thresholds, whether position errors remain above acceptable limits for a specified time, or whether image detection indicates an unexpected obstruction or missing part. If an abnormal state is detected, the server generates stop commands and transmits them to the mechanism controller. The server also generates updated procedure data that includes diagnostic messages for the user, such as “Check if part A is correctly inserted,” and transmits presentation data to the terminal to display the diagnostic messages. This integration of textual and sensory reasoning enables the system to respond to real-world anomalies in a structured and explainable manner.

The server generates presentation data for the terminal by formatting the procedure data into a step-by-step representation. The server may generate text suitable for display as numbered lists, highlight warnings by inserting “WARNING:” prefixes and specifying color attributes, and include illustration metadata that describes what should be shown in an accompanying image. The server can also prepare text to be passed to a text-to-speech engine, which may be executed on the server or on the terminal, to create audio guidance synchronized with displayed steps. The terminal receives the presentation data and renders a user interface using its native application framework, presenting step instructions, icons, and progress indicators.

The user may use control elements on the terminal to navigate between steps, request more detail, simplify instructions, or enable robotic execution.

The server supports dynamic refinement of procedure data. When the user presses a “More detail” or “Simplify” control on the terminal, the terminal sends a refinement request including the current step identifier and the desired adjustment (“more detail” or “simplify”).

The server constructs an additional prompt sentence such as:
“Rewrite the following step to be simpler and easier for a non-technical user to understand, while preserving all safety warnings and keeping the step logically complete: [current step text].”
“Expand the following step into sub-steps that specify the order of tool placement, approximate rotation angles, and target positions more precisely, for an expert user: [current step text].”

The server supplies this prompt sentence and the associated step context to the generative AI model, generates regenerated procedure data for the targeted step, validates the regenerated content against the original structured data and warning set, and updates the stored procedure data and the presentation data. The terminal then updates its display and, if applicable, requests new audio output. In this way, the server uses the generative AI model not as a monolithic summarizer, but as a controlled transformation component within a larger, verifiable data pipeline.

This architecture yields specific technical effects. By converting manual content to a structured representation before invoking the generative AI model, the server reduces the complexity of the generative task and constrains the model's output space, which reduces errors in safety information and step ordering. By using explicit prompt sentences that codify output format, length limits, and warning marking rules, the server produces outputs that are easier and faster to parse programmatically, reducing CPU cycles and memory overhead for validation and mapping to operation templates. By integrating the resulting procedure data directly into motion planning and closed-loop robot control, the server enables automatic derivation of control commands from manual content in a manner that is not feasible with human-only or rule-only approaches. Measured over multiple tasks, this can result in shorter programming time for new products, reduced misassembly rates, and improved throughput.

In another embodiment, the terminal may perform a subset of natural language processing locally, such as sentence segmentation and preliminary classification, and send partially structured data to the server. This reduces communication bandwidth and latency, particularly when network conditions are constrained. In yet another embodiment, the generative AI model may execute on the terminal if sufficient computing resources are available, with the server acting primarily as a coordinator and repository. In such a case, the same structured prompting and validation techniques apply, but the data flow between server and terminal is adapted to local inference.

In yet another embodiment, the system may operate without the multi-joint work mechanism, providing only adaptive presentation of procedures to the user. Even in this configuration, the structured NLP pipeline, constraint-driven prompt sentence construction, and controlled generative AI output improve the functioning of the computing system by yielding more accurate, more efficiently processed, and more contextually appropriate instructional data than a simple scan-and-display system.

Across these embodiments, the use of a generative AI model in conjunction with explicit prompt sentences, structured manual data, and sensor-driven control results in a non-conventional, non-generic implementation of computer technology. The server does not merely automate human reading and summarization, but instead implements a specific data structure design, model architecture integration, and control algorithm pipeline that improves data management, recognition accuracy, control precision, and computational efficiency, and that is tightly coupled to the technical task of controlling an automated multi-joint work mechanism and presenting procedures to a user terminal.

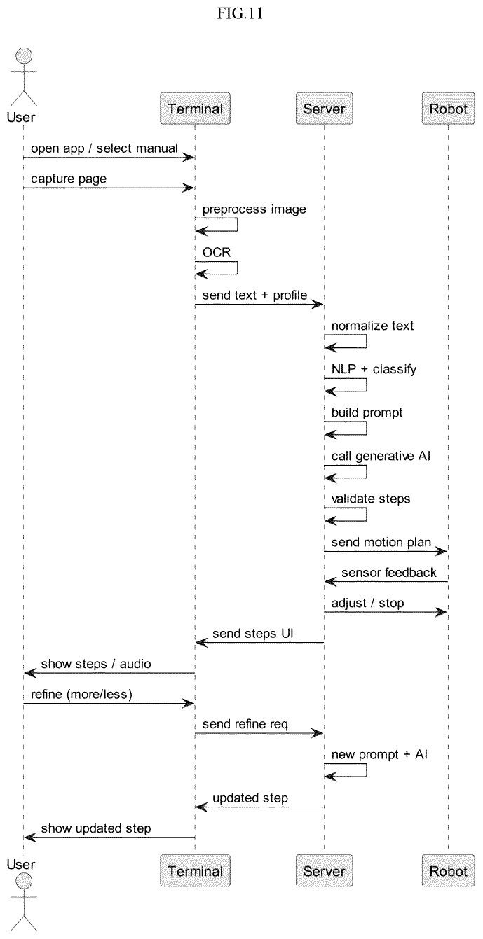

The following describes the processing flow using FIG. 11.

### Step 1:

The user operates the terminal to launch an application and select a target manual.

Input: physical paper manual, user selection.

Output: live camera preview on the terminal.

The terminal activates an image capturing module via an operating system camera API and displays a real-time preview of the manual on the screen. The terminal adjusts autofocus, exposure, and white balance based on sensor readings, performing internal calculations to maximize contrast and sharpness of text regions. The user positions the manual within a guide frame shown on the display so that all relevant pages are visible.

### Step 2:

The user operates the terminal to capture one or more images of the manual.

Input: live camera preview, user capture command.

Output: stored image files of manual pages.

The terminal receives a capture command from a user interface control, triggers the camera shutter, and stores the captured frames as high-resolution image data (for example, JPEG files) in terminal memory. The terminal assigns each file a page index and timestamps and records basic metadata such as resolution and orientation.

### Step 3:

The terminal preprocesses the captured image information for OCR.

Input: raw image files of manual pages.

Output: preprocessed image buffers suitable for text recognition.

The terminal reads each image file into memory and executes image processing operations using an image processing library. The terminal converts the images to grayscale, applies a noise reduction filter (for example, a Gaussian blur), and performs binarization by computing a threshold and mapping pixels above and below the threshold to high and low intensity values. The terminal detects page boundaries by finding contours, estimates document corner points, and applies a projective transform to correct perspective distortion. As a result, the terminal outputs normalized, deskewed image buffers in a format expected by an OCR engine.

### Step 4:

The terminal executes optical character recognition on the preprocessed images.

Input: preprocessed image buffers.

Output: machine-readable character string data with layout metadata.

The terminal passes each image buffer to an OCR engine and receives recognized text blocks, including line text, character confidences, and bounding box coordinates. The terminal aggregates recognition results into a structured layout representation, assigning line indices, paragraph indices, and page numbers. The terminal performs basic post-processing, such as merging hyphenated words and normalizing character encodings, and stores the final character string data and layout metadata in an internal data structure.

### Step 5:

The terminal collects user attribute information and sends manual data to the server.

Input: character string data with layout metadata, user profile settings.

Output: JSON or similar request payload transmitted to the server.

The terminal retrieves user attribute information, such as skill level and preferred language, from local storage or user input fields. The terminal constructs a payload that includes the character string data, layout metadata, and user attribute fields. The terminal serializes this payload into a JSON object, computes its size, and sends it to the server via a secure communication connection. The terminal monitors transmission status and may display a “Processing” indicator while waiting for the server response.

### Step 6:

The server receives and normalizes the manual text data.

Input: JSON payload containing manual text and user attributes.

Output: normalized text and metadata stored in server memory and storage.

The server parses the JSON payload and extracts the character string data, layout metadata, and user attribute information. The server performs text normalization by applying Unicode normalization, removing extraneous whitespace, and replacing irregular line breaks. The server stores the normalized text and metadata in a persistent storage layer and creates an in-memory representation where each token includes text content, position indices, and references to page locations.

### Step 7:

The server performs natural language processing and classification of sentences.

Input: normalized character string data.

Output: structured data with sentence categories and linguistic annotations.

The server runs a tokenizer to segment the text into sentences and word tokens. The server computes part-of-speech tags and dependency parses for each sentence using a natural language processing model. The server then applies a trained sequence labeling model to classify each sentence into categories such as procedure, warning, tool requirement, or note.

Internally, the server converts each sentence into an embedding vector sequence, processes it through a transformer encoder, and applies a classification layer to obtain category probabilities. The server assigns each sentence the category with highest probability and stores the classification results together with linguistic annotations in a structured data object.

### Step 8:

The server extracts task procedure information, caution information, component information, and tool information.

Input: structured data with sentence categories and syntactic/semantic analysis.

Output: procedure records with associated warnings, components, and tools.

The server scans sentences classified as procedure and uses dependency relations to identify action verbs and their objects. The server retrieves noun phrases representing components and tools and links them to corresponding procedure sentences. The server also associates warnings and notes with nearby procedure sentences by analyzing sentence order and reference expressions. The server constructs procedure records that include step candidates, each record containing an action, an object, associated components, associated tools, and linked caution information.

### Step 9:

The server performs term conversion based on user attributes.

Input: procedure records and user attribute information.

Output: updated procedure records with generic term fields.

The server checks the user's skill level and language preference. If the user is a beginner, the server consults a glossary table that maps technical terms to generic or simplified forms. The server replaces technical terms in display fields with simpler synonyms or descriptive names, while retaining original terms in separate fields for traceability. The server thereby creates procedure records that contain both a technical field and a user-facing field, which allows subsequent modules to select appropriate wording without losing detailed information.

### Step 10:

The server constructs a prompt sentence for a generative AI model.

Input: structured procedure records and user attribute information.

Output: prompt sentence text to be supplied to the generative AI model.

The server selects a prompt template based on user skill level and usage scenario (for example, initial summarization or step refinement). The server inserts constraints such as required warning prefixes, maximum step length, and output schema description into the template. The server then appends a serialized representation of the procedure records, including important fields such as step candidates and warnings. As a result, the server outputs a single prompt sentence or a sequence of sentences that precisely specify output format, level of detail, language style, and safety requirements.

### Step 11:

The server executes the generative AI model to generate procedure data.

Input: prompt sentence and serialized structured data.

Output: generated step-by-step procedure data containing steps, warnings, and illustration hints.

The server sends the prompt sentence and associated data to a generative AI model, such as a transformer-based language model, running locally or accessible via an inference API. The server configures model parameters including temperature and maximum output length. The model processes the input tokens, computes attention over context, and generates output tokens representing instructions for each step. The server receives the generated text and parses it according to the constraints specified in the prompt, identifying step numbers, instruction text, warnings, and illustration description segments. The server stores the parsed output as procedure data with explicit fields for each step.

### Step 12:

The server validates and normalizes the generated procedure data.

Input: generated procedure data and original structured data.

Output: validated and normalized procedure data suitable for presentation and control mapping.

The server compares steps and warnings in the generated procedure data with the original structured data derived from the manual. The server checks whether all warnings are present and whether step order is coherent. If any inconsistency is detected, the server may adjust the procedure data by inserting missing warnings or reordering steps based on the original structure. The server normalizes step numbers to a continuous sequence and ensures that text fields conform to maximum length constraints. The resulting procedure data constitutes a reliable, machine-interpretable representation of the manual for downstream modules.

### Step 13:

The server maps procedure steps to operation templates for the automated multi-joint work mechanism.

Input: validated procedure data.

Output: a list of instantiated operation templates with parameters.

The server examines each step for patterns indicating robotic execution feasibility, such as verbs “pick,” “place,” “insert,” or “tighten.” The server uses rule-based mappings and semantic roles to associate steps with operation templates like “transport,” “fastening,” or “alignment.” The server fills template parameters using known workcell configuration data, such as coordinates of fixtures and parts, and using component information from the procedure data. The server outputs a list of operation template instances representing high-level robotic actions derived from textual instructions.

### Step 14:

The server generates low-level motion and force commands for the multi-joint work mechanism.

Input: instantiated operation templates and robot configuration data.

Output: time-ordered sets of joint command values, position command values, and force command values.

The server performs kinematic calculations to convert end-effector target poses defined by operation templates into joint configurations, using a kinematics solver. The server invokes a trajectory planner to generate collision-free motion paths that satisfy speed and acceleration limits. The server computes force profiles by selecting grip forces and torques appropriate for the components, referencing a database of recommended forces when available. The server packages these values as sequences of low-level commands and sends them to the multi-joint work mechanism controller through a communication interface.

### Step 15:

The server processes sensor feedback and adjusts commands in real time.

Input: position detection information, force detection information, and image detection information from the multi-joint work mechanism.

Output: correction commands or stop commands transmitted to the multi-joint work mechanism.

The server receives sensor data streams and computes deviations between actual positions and commanded positions, and between actual forces and desired forces. The server applies a control algorithm, such as a PID controller, to generate corrections to joint command values or force command values, and transmits updated commands to the controller. The server processes image data to verify alignment and presence of parts and, when misalignment exceeds a threshold, adjusts target positions or halts motion. If the server detects an abnormal state, such as excessive force or unexpected blockage, the server sends a stop command and marks the step as failed in internal logs.

### Step 16:

The server generates presentation data for the terminal.

Input: validated procedure data and, optionally, execution status from the multi-joint work mechanism.

Output: presentation data containing step descriptions, warnings, and optional status indicators.

The server formats the procedure data for user presentation by generating a sequence of display records, each record including a step number, an instruction sentence, warnings prefixed with “WARNING,” and illustration hints. The server may add execution status information indicating whether a step is completed, in progress, or failed. The server optionally prepares text segments suitable for text-to-speech synthesis. The server transmits this presentation data to the terminal over the communication channel.

### Step 17:

The terminal presents the procedure and receives user refinement requests.

Input: presentation data and user interactions.

Output: updated display state and refinement requests sent to the server.

The terminal renders the step-by-step procedure as a graphical interface with numbered steps, warning icons, and navigation controls. The user browses steps, listens to audio guidance if available, and may press buttons labeled “More detail” or “Simplify.” The terminal detects these inputs and constructs refinement requests containing the current step identifier and desired adjustment type. The terminal then sends the refinement requests back to the server for additional processing and updates its display when revised presentation data is received.

### Step 18:

The server refines specific steps using additional prompt sentences.

Input: refinement requests and corresponding step content.

Output: regenerated procedure text for targeted steps.

The server retrieves the step identified in the refinement request and constructs an additional prompt sentence, for example: “Rewrite the following step to be simpler and easier for a non-technical user to understand, while preserving all safety warnings: [step text].” or “Expand the following step into more detailed sub-steps with explicit tool movements: [step text].” The server passes this additional prompt and context to the generative AI model, obtains regenerated text, validates it against the original structure and warnings, and updates the relevant step in the procedure data. The server regenerates presentation data for the updated step and sends it to the terminal, which replaces the displayed content accordingly.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented maintenance support systems generally rely on static rule sets, manually encoded workflows, and fixed mappings from textual manuals to machine actions. In such systems, a processor typically retrieves document data, performs simple keyword search, and provides human-oriented guidance, while low-level control software separately drives an automatic work mechanism such as a robot arm. This separation leads to several technical problems in the computing architecture.

First, when unstructured text such as operation manuals or service bulletins is used as a source of procedure information, conventional systems lack an effective mechanism to transform such text into machine-readable, stepwise instructions that can be executed safely and efficiently by an automatic work mechanism. Generative AI models have the potential to generate such instructions; however, naive integration of generative AI into control software introduces new failure modes. If the processor simply submits the raw manual text as input and accepts free-form natural language output from a generative AI model, the resulting instructions may be incomplete, ambiguous, or inconsistent with the constraints of the automatic work mechanism, thereby degrading system reliability and increasing the need for human supervision.

Second, in known architectures, the interaction between anomaly detection, document processing, and robot control is loosely coupled and largely manual. A processor may detect an abnormal state from sensor data and notify an operator, but it is not configured to close the loop from sensor-based diagnosis to automatic generation of motion plans. As a result, the processor cannot automatically compute, from heterogeneous input data, a consistent internal representation of a work procedure that is suitable for deterministic expansion into primitive robot actions and real-time control parameters. This leads to inefficient utilization of computational resources, repeated manual encoding of similar procedures, and limited scalability across different apparatuses and fault types.

Third, conventional systems do not adapt the prompt design and output format of generative AI in response to historical execution data. The processor typically uses fixed prompt texts and fixed patterns of interaction with the generative AI model, which do not evolve as more jobs are completed. Consequently, the system fails to leverage accumulated work history, error logs, and performance metrics to improve the quality and stability of AI-generated procedures. This limits the ability of the computing system to optimize latency, reduce error rates, and enforce machine-oriented safety constraints in subsequent runs.

Fourth, existing solutions often provide only coarse-grained integration between high-level AI outputs and low-level motion control. A processor may display AI-generated steps to a human operator, who then manually translates them into robot programs using separate tools. This split workflow prevents the processor from verifying consistency between the AI output and the kinematic, force, and workspace limits of the automatic work mechanism, and from applying real-time corrections based on sensor feedback. As a result, the computing pipeline remains brittle: small deviations in environment or modeling require human reprogramming or ad hoc adjustments, which in turn increases downtime and undermines the benefits of automation.

Accordingly, there is a need for an improved computer-implemented system and processing method in which a processor: (i) integrates sensor-based abnormal state analysis with document-based procedure extraction; (ii) automatically generates context-rich prompt sentences and requests structured, machine-readable output from a generative AI model; (iii) transforms the structured output deterministically into motion planning information for an automatic work mechanism, with real-time correction capability; and (iv) continuously refines the prompt design and procedure structure using accumulated execution data. Such a system would improve the functioning of the computer itself by providing a more robust, adaptive, and efficient pipeline from heterogeneous input data to executable control data, thereby reducing computational errors, minimizing manual intervention, and enhancing the reliability and throughput of automated maintenance operations.

The specific processing by the specific processing unit 290 of the data processing device 12 in Application Example 1 is realized by the following means.

The present invention provides a server comprising a processor configured to: acquire printed information by controlling an imaging unit; convert the acquired printed information into electronic information including character information by executing a character recognition process; acquire operation state information as time-series information from multiple state detection elements provided for multiple apparatuses and store the operation state information in a storage; analyze the stored operation state information to determine presence or absence of an abnormal state and to estimate a cause of the abnormal state; extract, by executing a natural language information extraction process, procedure information and caution information related to the estimated cause of the abnormal state on the basis of the electronic information obtained by the character recognition process and a result of the analysis; generate, by executing a generative-AI cooperation process, a prompt sentence in a predetermined format including the procedure information and the caution information, automatically incorporate context information including at least the estimated cause of the abnormal state, a type of a target apparatus, performance constraints of an automatic work mechanism, and safety conditions into the prompt sentence, input the prompt sentence and the procedure information to a generative AI model, and acquire output information from the generative AI model, the output information including a work procedure executable by the automatic work mechanism and conforming to a structured, machine-readable output format; convert, by executing a motion-planning generation process, the work procedure into a sequence of basic actions including at least a grasping action, a positioning action, a fastening action, and an inserting action, add correction information based on position information and force information of an object to be handled, and generate motion planning information for the automatic work mechanism; drive the automatic work mechanism on the basis of the motion planning information by executing a work-mechanism drive process; acquire joint position information, force information, and external detection information of the automatic work mechanism, apply real-time correction to the motion planning information, and perform safety stop control and restart control of the automatic work mechanism by executing an operation control process; cause a display and input interface to present abnormal condition information, work procedure information, and progress information generated by the analysis and the generative-AI cooperation process, receive from a user an instruction including at least one of approval of a work plan, a change of a parameter, and a stop command, and reflect the instruction in the motion-planning generation process and the operation control process; and accumulate past abnormal state information, work history information, and work result information in the storage, analyze trends of abnormal state occurrence and work time on the basis of the accumulated information, and automatically update constraint conditions, required accuracy, and safety procedure descriptions included in the prompt sentence in accordance with a result of the analysis so as to optimize content and order of the work procedure obtained from the generative AI model by a learning-based method. This enables the computer-implemented system to establish a closed-loop processing pipeline from heterogeneous sensor and document inputs to deterministic, robot-executable motion plans, to obtain structured outputs from the generative AI model that are directly consumable by motion planning software, to perform real-time correction and safety control of the automatic work mechanism based on feedback, and to adapt prompt design and procedure structure over time using accumulated execution data, thereby improving reliability, efficiency, and autonomy of maintenance and repair operations executed under control of the processor.

The term “printed information” refers to information represented on a physical medium in a human-readable form, including but not limited to text, symbols, diagrams, and figures printed or otherwise formed on a sheet-like substrate.

The term “imaging unit” refers to hardware configured to capture an image of an object or area, including at least an image sensor, an optical system, and associated control circuitry capable of generating digital image data from printed information.

The term “electronic information” refers to information represented in a machine-readable digital format, including character codes, structured text data, metadata, and associated control data stored or processed by a computing device.

The term “character information” refers to digital data representing individual characters, numerals, symbols, or glyphs obtained through a character recognition process from an image of printed information.

The term “character recognition process” refers to a sequence of software-implemented operations that analyze image data to detect, segment, and classify character shapes and output corresponding character codes or text strings.

The term “state detection element” refers to a sensing element or detector arranged to measure at least one physical or operational quantity of an apparatus, such as temperature, vibration, sound, position, current, or pressure, and to output corresponding measurement data.

The term “operation state information” refers to time-dependent data describing an operating condition of an apparatus, including sensor measurements, status flags, event logs, or derived features indicating normal or abnormal behavior.

The term “time-series information” refers to data values associated with respective time points or time intervals, enabling analysis of changes in one or more quantities over time.

The term “storage” refers to a memory resource accessible by a processor, including volatile and non-volatile memory devices, used to store programs, configuration data, intermediate data, and historical records.

The term “abnormal state” refers to an operating condition of an apparatus that deviates from a predefined normal range or pattern, as determined by analysis of operation state information.

The term “cause of the abnormal state” refers to a fault type, failure mode, or underlying condition inferred by analysis of operation state information and associated data, which is deemed responsible for the abnormal state.

The term “natural language information extraction process” refers to processing operations that analyze electronic text using natural language techniques to identify and extract specific information such as procedures, cautions, parameters, or entities relevant to a task.

The term “procedure information” refers to information representing a sequence of actions, operations, or steps to be performed for achieving a specific technical objective, such as repair, maintenance, adjustment, or inspection.

The term “caution information” refers to information describing precautions, warnings, safety measures, or constraints that should be considered when executing a procedure.

The term “generative-AI cooperation process” refers to a set of operations in which a processor prepares input data including at least a prompt sentence, supplies the input data to a generative AI model, receives output from the generative AI model, and integrates the output into subsequent computational processes.

The term “prompt sentence” refers to textual input provided to a generative AI model, including instructions, context, constraints, and desired output format specifications, used to guide generation of output information by the model.

The term “generative AI model” refers to a machine-learned model configured to generate text or other data in response to an input prompt, based on parameters obtained by training on example data using a learning algorithm.

The term “output information” refers to data generated by the generative AI model in response to the prompt sentence, including at least a representation of a work procedure and optionally additional structured attributes.

The term “work procedure” refers to a set of ordered actions, expressed in natural language or structured form, that specify how an automatic work mechanism is to perform a maintenance, repair, assembly, disassembly, or inspection task.

The term “automatic work mechanism” refers to a controllable mechanical system, such as a robot arm, manipulator, or automated tool, having at least one actuated joint or degree of freedom and configured to execute physical operations according to control commands.

The term “basic action” refers to a primitive operation of the automatic work mechanism, including at least a grasping action, a positioning action, a fastening action, and an inserting action, which can be combined to implement higher-level procedures.

The term “position information” refers to data indicating a spatial location and/or orientation of an object or component, or of a part of the automatic work mechanism, in a defined coordinate system.

The term “force information” refers to data indicating a magnitude and direction of a force or torque applied to or experienced by an object or by the automatic work mechanism, obtained from sensors or estimated by computation.

The term “correction information” refers to modification data calculated on the basis of position information, force information, or other feedback, and used to adjust motion planning information so that the automatic work mechanism can compensate for deviations or uncertainties.

The term “motion planning information” refers to data representing a planned motion of the automatic work mechanism, including at least a sequence of poses, trajectories, speeds, accelerations, and associated timing and control parameters.

The term “work-mechanism drive process” refers to processing in which control commands are generated and transmitted to actuators or a controller of the automatic work mechanism based on motion planning information.

The term “operation control process” refers to processing that acquires feedback information from the automatic work mechanism and external sensors, performs real-time comparison with motion planning information, and adjusts control commands, including performing safety stop and restart control.

The term “joint position information” refers to data indicating the positions, angles, or displacements of joints or axes of the automatic work mechanism at one or more points in time.

The term “external detection information” refers to data from sensors not integral to the joints of the automatic work mechanism, such as proximity sensors, environmental cameras, or area scanners, indicating environmental conditions or external objects.

The term “display and input interface” refers to a user interface including at least one display device and at least one input device, configured to present information to a user and to receive user commands, approvals, or parameter changes.

The term “abnormal condition information” refers to information presented to a user that describes at least the existence, nature, and estimated cause of an abnormal state detected in an apparatus.

The term “work procedure information” refers to data representing a work procedure in a human-readable or machine-readable form, including step descriptions, associated parameters, and safety notes.

The term “progress information” refers to information indicating a current execution state of a work procedure, including at least which step is being executed, which steps have been completed, and corresponding timing.

The term “approval of a work plan” refers to a user input indicating consent to execute a generated work procedure, optionally with specified parameters, using the automatic work mechanism.

The term “change of a parameter” refers to a user input that modifies at least one execution parameter, such as speed, torque limit, position tolerance, or scheduling, of a work procedure.

The term “stop command” refers to a user input instructing the system to halt or suspend execution of at least part of a work procedure by the automatic work mechanism.

The term “context information” refers to data describing conditions and constraints relevant to generation of a work procedure by the generative AI model, including at least an estimated cause of an abnormal state, a type of a target apparatus, performance constraints of the automatic work mechanism, and safety conditions.

The term “structured, machine-readable output format” refers to an arrangement of data into a predefined schema, such as a hierarchical or tabular structure with named fields, that can be parsed and processed deterministically by software without natural language understanding.

The term “step number” refers to a numerical identifier assigned to a discrete action or sub-procedure within a work procedure to define its order.

The term “target portion” refers to a specific part or region of an apparatus or object on which a particular step of the work procedure is to be executed.

The term “tool to be used” refers to an instrument, end effector, or attachment designated for use by the automatic work mechanism or a human in executing a particular step of the work procedure.

The term “allowable torque value” refers to a numeric limit specifying a maximum or target torque that may be applied in a fastening, loosening, or rotational operation within the work procedure.

The term “required time” refers to an estimated duration needed to execute a particular step or the entire work procedure under nominal conditions.

The term “safety confirmation item” refers to a specific check, measurement, or verification that is to be performed to ensure safety before, during, or after execution of a step in the work procedure.

The term “hierarchical structure data” refers to data organized in levels of containment, such as steps, sub-steps, and associated attributes, represented for example in a tree or nested structure.

The term “work history information” refers to recorded data describing previously executed work procedures, including executed steps, parameters used, timing, and any deviations or errors that occurred.

The term “work result information” refers to data indicating outcomes of executed work procedures, including success or failure status, remaining anomalies, and post-execution measurements.

The term “trend of abnormal state occurrence” refers to a pattern, frequency, or evolution over time of detected abnormal states, determined by statistical or analytical processing of accumulated abnormal state information.

The term “required accuracy” refers to a quantitative or qualitative specification of allowable error or tolerance in position, force, or other measurable quantities during execution of a work procedure.

The term “safety procedure description” refers to textual or structured data that describes steps, constraints, or sequences intended to avoid or mitigate hazards during execution of a work procedure.

The term “learning-based method” refers to a method that employs one or more machine-learning techniques, such as supervised learning, unsupervised learning, or reinforcement learning, to adjust parameters, structures, or policies based on example data.

The term “prompt design” refers to selection, structuring, and wording of a prompt sentence, including embedded context and formatting instructions, used to control behavior of a generative AI model.

The term “procedure structure” refers to the organization of a work procedure into steps, sub-steps, dependencies, and associated attributes defining its execution order and relationships.

In one embodiment, server implements the claimed system as a combination of hardware components and software modules executing on a general-purpose computing platform.

Server includes at least one processor, a memory, a non-transitory storage device, a network interface, and an interface to an automatic work mechanism. The automatic work mechanism may be a multi-joint robot arm equipped with a gripping tool and a fastening tool, a force/torque sensor, and one or more cameras. The memory stores program instructions that, when executed by the processor, cause server to perform the functions described below.

Server controls an imaging unit that may be realized by a high-resolution camera. The imaging unit can be an industrial digital camera connected via a standard interface such as USB or Ethernet. Server acquires images of printed information, such as paper-based manuals or service bulletins, by triggering the imaging unit and receiving digital image data in a structured image buffer. The image buffer may be represented as a two-dimensional array of pixel intensity values stored in memory.

Server executes a character recognition process on the image buffer. In one implementation, server invokes an optical character recognition engine, such as an engine based on convolutional neural networks and recurrent neural networks. The OCR engine converts the image buffer into character information by segmenting text regions, normalizing character images, and classifying each character into a code point sequence. Server stores resulting text strings in a text data structure including fields for page index, bounding box coordinates, and recognized text. This conversion from bitmap to text reduces storage size and enables subsequent natural language analysis, which improves both processing speed and downstream extraction accuracy.

Server acquires operation state information from multiple apparatuses through state detection elements. The state detection elements may include temperature sensors, vibration sensors, and acoustic sensors, each connected to a controller such as a programmable logic controller or an industrial gateway. Server receives measurement values as time-stamped records via a communication protocol such as an industrial fieldbus or a TCP/IP-based protocol. Server stores these records as time-series information in a data structure that associates each measurement with an apparatus identifier, a sensor type, a timestamp, and a measured value.

In one implementation, server uses a time-series database optimized for high-volume streaming data and compressed storage formats, thereby improving I/O efficiency and query performance.

Server analyzes the stored operation state information to determine presence or absence of an abnormal state and to estimate a cause of the abnormal state. In one embodiment, server computes feature vectors from sliding windows of sensor data. For vibration data, server computes root-mean-square amplitude, spectral peak positions obtained by a fast Fourier transform, and higher order statistics. For temperature data, server computes moving averages and gradients. For acoustic data, server computes frequency band energies and spectral entropy. Server concatenates these features into a multivariate feature vector for each time window.

Server applies an anomaly detection model implemented as a trained neural network or a statistical model. In one example, server uses an autoencoder neural network having multiple fully connected layers, where an input layer receives the feature vector, one or more hidden layers encode and decode a compressed representation, and an output layer reconstructs the original feature vector. Server computes a reconstruction error as a difference between the input vector and the reconstructed vector, and compares the reconstruction error with a threshold that has been determined from training data representing normal operation. When the reconstruction error exceeds the threshold, server determines that an abnormal state is present. This autoencoder-based approach, which models normal behavior in a high-dimensional feature space and detects deviations as reconstruction errors, enables more accurate and earlier detection of subtle faults than simple threshold checks on raw signals.

Server further estimates a cause of the abnormal state by applying a classification model. In one embodiment, server uses a neural network classifier that receives the same feature vector and outputs a probability distribution over fault types, such as bearing wear, imbalance, misalignment, and lubrication failure. The classifier may be trained using supervised learning with cross-entropy loss, and server updates its weights during training by gradient descent based on labeled training data stored in the storage device. By combining unsupervised anomaly detection with supervised fault classification, server reduces false positives and improves the quality of fault diagnosis, thereby enhancing the reliability of subsequent automated actions.

Server performs a natural language information extraction process on the electronic text obtained by the character recognition process. Server uses a natural language processing pipeline that includes sentence segmentation, tokenization, part-of-speech tagging, and syntactic parsing. Server identifies sentences that describe procedures and cautions by applying a sequence labeling model, such as a bidirectional recurrent neural network with a conditional random field layer. This model assigns labels like “STEP_ACTION,” “STEP_OBJECT,” “TOOL,” “TORQUE_VALUE,” and “SAFETY_NOTE” to tokens in the text. Server groups tokens having the same step identifier into structured records representing procedure information and caution information. This structured representation allows server to isolate only those portions of the manual that are relevant to the diagnosed fault and to supply them in a concise form to a generative AI model, reducing both data transfer volume and processing load.

Server executes a generative-AI cooperation process to convert the extracted procedure information and caution information into a work procedure that is executable by the automatic work mechanism. In this process, server generates a prompt sentence in a predetermined format and automatically incorporates context information. The context information includes an identifier of the estimated cause of the abnormal state, a type and model category of the target apparatus, performance constraints of the automatic work mechanism such as maximum reach, maximum torque, and maximum speed, and safety conditions such as no-go zones or restricted workspace regions.

In one embodiment, server constructs the prompt sentence by retrieving a template from configuration data and replacing placeholders with context values and selected procedure segments. An example prompt sentence is:

“Summarize the procedure to repair the detected main drive motor bearing wear on the target machine. Use only the following manual excerpts. Generate clear, numbered steps that a 6-axis robot arm with a parallel gripper and a torque screwdriver can execute. Use verbs like ‘grasp’, ‘position’, ‘loosen’, ‘remove’, ‘insert’, ‘tighten’, and ‘inspect’. For each step, specify tool, target part, and torque if applicable. Return the steps in a structured form with fields: step number, description, tool, target part, torque, and safety note.

### Manual Text:

[extracted procedure paragraphs]”

In another example, server uses the following prompt sentence:

“Summarize the procedure to repair the detected motor bearing failure on this machine.

Convert the instructions into explicit, step-by-step actions that a robot arm can execute without human interpretation. Avoid vague terms. Include lockout/tagout at the beginning, alignment checks before insertion, and a final verification step. For each step, indicate the required tool, the target component, and any safety check.”

Server submits the prompt sentence together with the extracted procedure information as input to a generative AI model. The generative AI model may be a large-scale transformer-based neural network including multiple attention layers and feed-forward layers, trained on a corpus of technical texts to perform instruction generation and summarization.

Server configures the model to produce a constrained output by including explicit instructions in the prompt regarding output format, such as requiring numbered steps and named fields.

This prompt design causes the model to emit structured text that server can parse deterministically, which reduces the need for ambiguous natural language understanding at later stages and improves robustness of the entire pipeline.

Server parses the generated work procedure from the model output, detecting step numbers, descriptions, tools, target parts, torque limits, and safety notes. Server stores the parsed work procedure in a data structure in which each step record includes identifiers, textual labels, and numeric parameters. By using this structured representation, server can programmatically transform the work procedure into motion planning information without requiring human programming or manual translation.

Server converts the work procedure into a sequence of basic actions. For each step, server refers to a configuration database that associates target parts with three-dimensional coordinates in a robot coordinate system, approach directions, and preferred gripping points.

Server decomposes high-level instructions such as “loosen motor cover screws” into basic actions including moving the tool center point to a pre-approach pose, moving to the screw head pose, engaging the tool, applying rotational motion with torque limits, detecting a change in torque indicating the screw is loose, and placing the screw in a storage location.

Server stores this decomposition as motion planning information including trajectories represented as sequences of joint targets and time stamps, speed profiles, and torque constraints.

Server uses motion planning algorithms such as sampling-based planners or optimization-based trajectory generators to ensure that the planned motions do not violate workspace constraints, collision avoidance requirements, or dynamic limits of the automatic work mechanism. Server applies forward and inverse kinematics computation to convert between Cartesian poses and joint positions. Server incorporates correction information derived from position information and force information. For example, server uses force sensor feedback to adapt insertion depth and orientation when inserting a new bearing, adjusting the trajectory in real time when contact forces exceed or fall below expected ranges.

This integration of AI-generated procedures with low-level feedback control enables server to handle variations in component tolerances and fixture positions without manual reprogramming.

Server executes an operation control process in which it receives joint position information, force information, and external detection information from sensors attached to or around the automatic work mechanism. Server compares measured values against expected values derived from the motion planning information. When deviations are within a predetermined tolerance range, server adjusts motion commands by applying small corrections to joint targets or speeds. When deviations exceed safety thresholds, server generates stop commands to the automatic work mechanism controller and records the event, including error codes and sensor values. By performing this real-time comparison and correction loop, server improves safety and precision beyond what static, pre-programmed trajectories can provide.

Terminal provides a display and input interface to present information to user. Terminal may be a tablet computer, a workstation, or another display device connected to server via a network. Server transmits abnormal condition information, work procedure information, and progress information to terminal in a structured format. Terminal renders these data as visual elements, such as lists of steps, status indicators, and warnings. User reviews the generated work procedure and confirms whether the automatic execution is acceptable. User can also adjust execution parameters such as speed, torque limits, and scheduling windows by entering values through terminal. Terminal sends these user instructions back to server, which reflects them in the motion planning information and operation control parameters.

Server accumulates past abnormal state information, work history information, and work result information in storage. Server periodically analyzes trends of abnormal state occurrence and work time using statistical processing and machine-learning methods. For example, server may compute distributions of execution times per fault type and the frequency of emergency stops during specific steps. Server may apply clustering algorithms to group similar failures and may compute feature importance values for different context parameters.

Based on these analyses, server automatically updates prompt design and constraint descriptions. For instance, if server detects repeated misalignment problems during bearing insertion, server modifies the prompt sentence to emphasize alignment checks and additional safety verifications. Because server adjusts prompt content and constraints based on quantitative history, the generative AI model is guided to produce more conservative or more detailed procedures where needed, which reduces error rates and rework.

Server also may adjust parameters of the anomaly detection and classification models by retraining with newly labeled data. Server stores execution outcomes, including whether the generated procedure succeeded without human intervention and whether any manual corrections were applied. Server uses this supervision to refine the classification thresholds and model weights, thereby improving the precision and recall of fault detection and diagnosis. This learning-based adaptation of internal models and prompt design constitutes an improvement in computer technology because server uses feedback from its own performance to reconfigure how it processes sensor data, text data, and AI outputs, rather than simply automating a fixed human workflow.

By structuring data into well-defined internal representations and by constraining the generative AI model through context-rich prompt sentences, server reduces communication bandwidth between components and reduces computational overhead for parsing and error handling. The system does not merely display AI-generated text but converts it into concrete control data for the automatic work mechanism. This provides a technical effect in the physical world, namely controlled actuation of the robot for maintenance and repair operations with increased accuracy and reduced downtime.

In another embodiment, server executes similar processes but uses alternative algorithms. For example, server may implement the natural language information extraction process using a transformer-based encoder model fine-tuned for token classification, and may implement anomaly detection using an isolation forest or a one-class support vector machine instead of an autoencoder. The generative AI model may be hosted on-premises or accessed as a remote service, and its architecture may vary, provided that server supplies structured prompts and receives structured outputs. The automatic work mechanism may be a different type of robot, such as a gantry robot or a mobile manipulator, and server may maintain different mapping tables to associate semantic step descriptions with motion primitives appropriate for the specific robot type.

In yet another embodiment, server may operate with a reduced set of sensors or document sources. For instance, if printed manuals are not available, server may process digital manuals stored as electronic files and perform equivalent natural language extraction and prompt construction on those files. If certain sensors are absent, server may use only vibration and current measurements and adjust its feature extraction methods accordingly. The underlying architecture, in which server integrates multi-modal data, generates context-dependent prompt sentences, and transforms generative AI outputs into motion planning information with feedback-based correction, remains the same.

By implementing the described modules and data flows, server improves computer technology in at least the following ways. Server enhances processing speed and reliability by using structured internal representations and machine-readable formats for AI outputs, reducing parsing errors and manual intervention. Server improves accuracy of fault detection and procedure generation through the use of multi-stage neural network models and feedback-driven prompt adaptation. Server improves data management by organizing sensor data, text data, AI outputs, and execution logs into interlinked databases that support efficient querying and learning. Server reduces communication load by transmitting only necessary, compressed features and structured results between modules and devices. Finally, server enables autonomous, safe control of complex mechanical equipment in response to heterogeneous data inputs, which extends computer functionality beyond conventional document retrieval or simple rule-based automation.

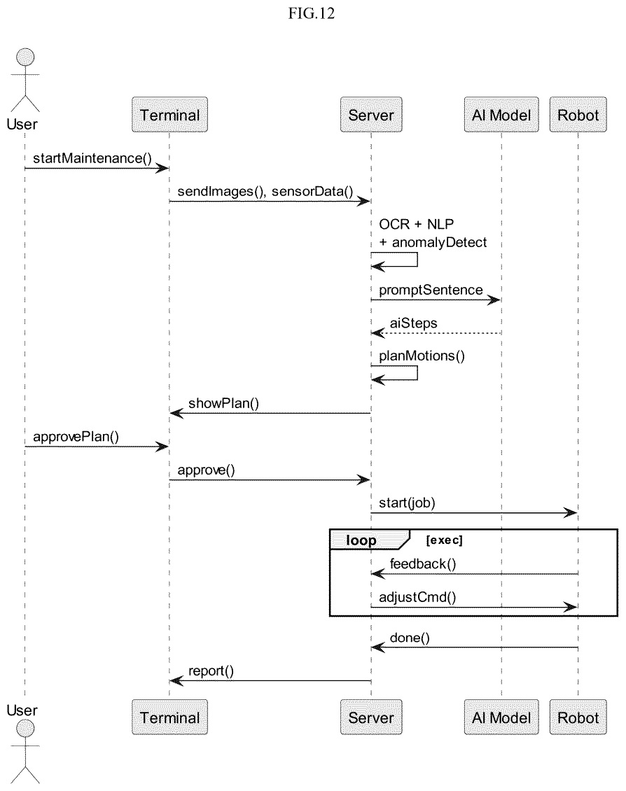

The following describes the processing flow using FIG. 12.

### Step 1:

Server acquires raw image data of printed information.

Server uses the imaging unit to capture an image of a paper manual or printed bulletin and receives a digital bitmap as input. Server stores this bitmap as a two-dimensional array of pixel values in memory and tags it with metadata such as capture time and document identifier. Based on this input array, server performs basic preprocessing operations including grayscale conversion, noise reduction, and geometric correction to obtain a cleaned image as output for subsequent character recognition.

### Step 2:

Server converts the cleaned image into electronic text.

Server inputs the preprocessed bitmap from Step 1 into a character recognition process.

Server segments the image into text regions, detects lines and characters, and classifies each character using a trained recognition model, thereby transforming pixel patterns into character codes. Server outputs electronic text, organized into paragraphs with associated bounding boxes and page indices, and stores this text structure for later natural language processing.

### Step 3:

Server acquires time-series operation state information from apparatus sensors.

Server receives, as input, raw measurement values from multiple state detection elements such as temperature sensors, vibration sensors, and acoustic sensors. Server samples measurements over time through a communication interface, attaches timestamps and apparatus identifiers, and aggregates them into a time-series record. Server outputs structured time-series data objects containing sensor type, apparatus ID, timestamp, and numeric value, and stores them in a time-series database.

### Step 4:

Server computes features from the time-series data for anomaly detection.

Server reads, as input, a window of time-series data for each apparatus from the database.

Server applies numerical operations including moving average, standard deviation, fast Fourier transform, and higher-order statistics to each window. From these operations, server produces a feature vector that summarizes vibration spectra, temperature trends, and acoustic characteristics. Server outputs these feature vectors as input to anomaly detection and fault classification models.

### Step 5:

Server detects abnormal states and estimates fault causes.

Server inputs the feature vectors from Step 4 into an anomaly detection model, such as an autoencoder or an isolation-based algorithm. Server calculates reconstruction errors or anomaly scores and compares them to predetermined thresholds to determine whether each apparatus is in a normal or abnormal state. For detected anomalies, server passes the same feature vectors to a classification model that computes probabilities for candidate fault types and selects the most likely cause. Server outputs abnormal state records that include apparatus ID, anomaly score, and estimated fault type, and stores them in an anomaly log.

### Step 6:

Server selects relevant text segments from the electronic manual.

Server receives, as input, the electronic text from Step 2 and the abnormal state records from Step 5. Server searches for sections in the manual whose headings, keywords, or semantic similarity scores match the apparatus type and estimated fault type. Server uses natural language processing to identify and extract paragraphs that describe repair procedures, tools, torque values, and cautions. Server outputs a reduced text corpus containing only the relevant procedure information and caution information, organized by section and priority.

### Step 7:

Server performs natural language information extraction to structure manual content.

Server inputs the reduced text corpus from Step 6. Server applies a tokenization and tagging pipeline to assign labels such as action verb, target component, tool, parameter, and safety note to each token. Server groups labeled tokens into candidate steps and assigns internal identifiers to each step. By combining labeled tokens and sentence structures, server generates structured records for procedure information and caution information. Server outputs a normalized representation in which each record contains fields for step description, associated tools, target parts, numeric parameters, and safety annotations.

### Step 8:

Server constructs a context-rich prompt sentence for the generative AI model.

Server receives, as input, the structured procedure and caution records from Step 7, the abnormal state records from Step 5, and configuration data describing performance constraints of the automatic work mechanism. Server inserts these data into a prompt template, including information such as fault type, apparatus category, robot capabilities, and required output format. Server concatenates context descriptions, selected manual excerpts, and explicit formatting instructions to generate a single textual prompt sentence. Server outputs this prompt sentence as a string ready for submission to the generative AI model.

### Step 9:

Server submits the prompt sentence to the generative AI model and obtains structured output.

Server uses the prompt sentence from Step 8 and the structured procedure records from Step 7 as input to a generative AI model via an inference interface. Server sends these inputs over a network connection, specifying model parameters such as maximum response length and determinism settings. Server receives, as output, a generated work procedure described as numbered steps with associated fields such as tool, target part, torque, and safety note, in a predefined textual structure. Server parses this output into internal step records and stores the structured work procedure for planning.

### Step 10:

Server maps AI-generated steps to robot-oriented task descriptors.

Server takes, as input, the structured work procedure from Step 9 together with a configuration database that links target parts to robot coordinates, approach poses, and gripping strategies. Server converts each high-level step into robot-oriented task descriptors, assigning basic actions including “move,” “grasp,” “loosen,” “tighten,” “insert,” and “inspect.” Server computes associated parameters such as target poses, approach vectors, speed limits, and torque thresholds. Server outputs a list of robot tasks in which each task is bound to specific coordinates, tools, and control parameters.

### Step 11:

Server generates motion planning information for the automatic work mechanism.

Server inputs the robot task list from Step 10 and a kinematic model of the automatic work mechanism. Server computes joint-space trajectories by performing inverse kinematics for each target pose and by applying motion planning algorithms to avoid obstacles and respect joint limits. Server refines trajectories using dynamic constraints and sets time stamps, velocities, and accelerations for each segment. Server outputs motion planning information representing complete trajectories and timing profiles for all basic actions required by the work procedure.

### Step 12:

Server coordinates with terminal to obtain user approval and parameter adjustments.

Server sends, as input to terminal, a summary of the generated work procedure, including step descriptions, tools, and estimated durations derived from the motion planning information of Step 11. Terminal displays these details to user in a human-readable format. User reviews the proposed procedure and, through terminal, may approve the plan, adjust execution parameters such as maximum speed or torque limits, or reject the plan. Terminal outputs user commands and adjusted parameters, which server receives and applies as updates to the motion planning information and control configuration.

### Step 13:

Server dispatches the motion plan to the automatic work mechanism and initiates execution.

Server uses the finalized motion planning information from Step 11, updated by user inputs from Step 12, as input to a control interface connected to the automatic work mechanism.

Server translates planning data into low-level control commands, such as joint target positions and velocity profiles, and transmits these commands to a robot controller in scheduled segments. Server outputs control messages that cause the automatic work mechanism to perform the planned basic actions in the specified order and with the defined parameters.

### Step 14:

Server monitors real-time feedback and adjusts execution.

Server receives, as input, joint position information, force sensor readings, and external detection information from the automatic work mechanism while it executes the control commands from Step 13. Server compares measured values to expected values generated from the motion planning information, computes deviations, and determines whether they fall within tolerance thresholds. When deviations are small, server adjusts future joint targets and velocities to correct path errors. When deviations exceed safety limits, server issues stop commands and records detailed error data. Server outputs updated control commands and status reports reflecting the current execution state and any corrections applied.

### Step 15:

Terminal presents execution status and alerts to user.

Terminal receives, as input, execution status messages and alerts from server, including current step index, completion percentages, and any detected abnormal events. Terminal displays this information through progress indicators and notification panels. If an emergency stop or error occurs, terminal shows an alert message and may provide recommended actions or a summary of the error context. Terminal outputs any user responses, such as commands to resume, modify, or terminate the work, which server then processes in subsequent control decisions.

### Step 16:

Server logs execution history and associates outcomes with models and prompts.

Server inputs final execution data from Step 14, including completed steps, timing information, error occurrences, and any manual interventions indicated by user commands.

Server links this execution history with the specific work procedure, the generative AI model version, and the prompt sentence used in Step 8. Server stores these associations in a historical database, producing records that relate fault types, prompts, AI outputs, and execution results. Server outputs aggregated statistics and labeled datasets that are later used for model retraining and prompt design refinement.

### Step 17:

Server analyzes historical data to refine anomaly models and prompt design.

Server reads, as input, accumulated abnormal state records, work history logs, and work result summaries from storage. Server applies statistical analysis and machine-learning algorithms to detect patterns, such as frequent error-prone steps or fault types with high execution times.

Based on these analyses, server adjusts thresholds and parameters of anomaly detection and classification models and modifies templates used to construct prompt sentences, for example by adding explicit safety checks or parameter requests. Server outputs updated model parameters and revised prompt templates, which are applied in subsequent runs to improve detection accuracy, procedure quality, and overall system performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems for presenting operating manuals generally convert document images into text and, in some cases, apply simple summarization. Such systems are typically configured to perform fixed-format extraction and static presentation of instructions, without dynamically adapting to a user's comprehension state or emotional state. As a result, when the underlying document is long, complex, or highly technical, a user often struggles to follow the instructions, and the user interface fails to guide the user effectively through the task. This leads to increased cognitive load, repeated navigation, and inefficient interactions with the computing system, thereby degrading overall system usability and throughput.

Further, existing systems that cooperate with automated actuators or robot arms generally execute pre-defined motion sequences based on static procedure descriptions. These systems do not modify motion parameters, such as speed, acceleration, or safety margins, based on user state signals acquired from multimodal data including facial images, voice, and operation logs. Consequently, the control logic in such systems is not optimized to the real-time context of the user, and cannot dynamically trade off between safety and efficiency. When the user becomes confused or stressed, the robot continues to operate with the same parameters, which can contribute to user anxiety and reduce trust in the system.

From a computer technology perspective, current architectures fail to exploit advances in generative AI models and affective computing in an integrated manner. In particular, there is no adequate mechanism in conventional systems to: (i) transform raw manual images into rich structured data on a server using natural language processing, (ii) infer a user's emotional state from heterogeneous client-side sensor data using machine learning, and (iii) synthesize an adaptive prompt sentence for a generative AI model such that the generated procedure representation is automatically tailored to both the document content and the inferred emotional state. Without such a mechanism, the server cannot perform context-aware content generation and cannot provide a feedback loop in which user state directly influences both the presentation layer and device control parameters.

Therefore, there is a need for an improved computer-implemented system and server-side processing architecture that integrate document understanding, multimodal emotion estimation, and generative AI-based content generation, and that further use the generated content and inferred emotional state to control both user-interface presentation and robot arm motion. Such a system should reduce user confusion, lower interaction cost, and improve safety and efficiency by reconfiguring the behavior of the computing system itself based on real-time user state.

The specific processing by the specific processing unit 290 of the data processing device 12 in Example 2 is realized by the following means.

The present invention provides a server comprising a processor configured to receive image data of an operating manual from a client device, perform optical character recognition to obtain text data and layout information, perform natural language processing including sentence segmentation, morphological analysis, syntactic analysis, and sentence classification to generate structured data including procedure information and caution information, estimate an emotional state of a user based on at least one of facial expression image data, audio data, and operation history data received from the client device, generate a prompt sentence for a generative AI model based on the structured data, user attribute information, and the emotional state, cause the generative AI model to generate summarized procedure data by inputting the prompt sentence to the generative AI model, generate display data and audio guidance data according to the summarized procedure data and the emotional state, and set and output motion parameters for a work robot arm according to the summarized procedure data and the emotional state. This enables the server-centric computer system to dynamically adapt both human-machine interaction and robot control to the user's real-time state, thereby improving the efficiency, robustness, and usability of the underlying computing processes for manual understanding, instruction presentation, and automated task execution.

The term “operating manual” refers to a document that describes structures, functions, usage methods, assembly procedures, maintenance procedures, or safety precautions of an apparatus, device, machine, furniture, or other article, regardless of whether the document is provided in paper form or electronic form.

The term “image data” refers to pixel data representing a two-dimensional image or a sequence of images, including at least one image frame capturing at least part of an operating manual.

The term “imaging unit” refers to hardware and associated control logic configured to acquire image data, including at least an image sensor, an optical system, and an interface that enables a processor to control image capture.

The term “optical character recognition” refers to processing that analyzes image data including characters, detects character regions, and converts the characters into machine-readable text data together with position or layout information.

The term “text data” refers to machine-readable data representing one or more character strings obtained by optical character recognition from an image of an operating manual.

The term “layout information” refers to structural information indicating at least positions, sizes, ordering, and types of regions in an operating manual image, including one or more of line breaks, paragraph boundaries, headings, lists, and caption regions.

The term “natural language processing” refers to computational processing that analyzes text data in a natural language to perform one or more of tokenization, sentence segmentation, morphological analysis, syntactic analysis, semantic analysis, and sentence classification.

The term “structured data” refers to data in which information extracted from an operating manual is represented in a predefined data structure including identifiers and attributes so that different types of information, such as procedure information and caution information, are distinguishable by category and field.

The term “procedure information” refers to information indicating at least a sequence of operations or steps to be performed by a user or a device, the order of the operations or steps, and optional associations with required parts, required tools, and reference figures.

The term “caution information” refers to information indicating at least warnings, prohibitions, safety precautions, or conditions that should be observed when performing a procedure described in an operating manual.

The term “user attribute information” refers to information indicating characteristics of a user of the system, including at least one of a skill level, a preferred language, an identification code, and past usage history.

The term “facial expression image data” refers to image data including at least a region of a user's face suitable for analysis of facial expressions.

The term “audio data” refers to a digital representation of sound including at least speech, utterances, or non-speech vocalizations of a user, sampled and optionally compressed for analysis or playback.

The term “operation history data” refers to chronological data indicating user interactions with a client device, including at least events such as touch inputs, scroll operations, screen transitions, and timestamps associated with the events.

The term “emotional state” refers to information representing a psychological state of a user inferred from one or more signals, and including at least a classification label such as calm, confused, or stressed, and optionally a numeric score indicating a degree of stress or similar metric.

The term “emotional state estimation” refers to computational processing that uses a model to infer an emotional state of a user from at least one of facial expression image data, audio data, and operation history data.

The term “prompt sentence” refers to a text sequence supplied as input to a generative AI model, the text sequence including at least instructions regarding desired output content, output style, or output format, and contextual information including structured data, user attribute information, and emotional state.

The term “generative AI model” refers to a machine-learned model, including at least a neural network-based language model, configured to generate new text data in response to an input sequence such as a prompt sentence.

The term “summarized procedure data” refers to data generated by a generative AI model that represents procedure information of an operating manual in a simplified or reorganized form, and that may include, for each step, at least a title, a description, a caution sentence, an illustration instruction, and an audio guidance script.

The term “display data” refers to data defining visual content to be presented on a display device, including at least text, layout information, and optionally graphical emphasis elements associated with summarized procedure data.

The term “audio guidance data” refers to data defining content and parameters for audio output to guide a user, including at least text for speech synthesis and optionally metadata specifying speaking rate, pitch, or tone.

The term “information presentation device” refers to a device configured to present information to a user through at least one of a display unit and an audio output unit, and controllable by a processor based on display data and audio guidance data.

The term “work content” refers to a description of a physical operation or sequence of physical operations derived from summarized procedure data and assignable to a work robot arm for automated or semi-automated execution.

The term “work robot arm” refers to a manipulator having at least one joint and an end effector, and configured to perform physical operations such as grasping, moving, inserting, or tightening components under control of motion parameters.

The term “motion parameters” refers to one or more settings that determine behavior of a work robot arm during execution of a task, including at least one of motion speed, acceleration, trajectory, safety margin, force limit, torque limit, and degree of automation.

The term “degree of automation” refers to a level indicating to what extent a work robot arm automatically executes one or more steps of a procedure, including at least a fully automatic mode, a partially automatic mode, and a manual or user-assisted mode.

The term “processor” refers to one or more hardware processing units, such as central processing units, graphics processing units, or specialized accelerators, and associated control logic, that execute instructions to perform the functions described for the server or system.

The term “client device” refers to a computing device operated by a user, including at least an imaging unit, an audio input unit, a user input unit, and a communication interface, and configured to acquire data and communicate with the server.

The term “server” refers to a computing apparatus or a group of computing apparatuses including at least one processor and a memory, configured to execute server-side processing such as optical character recognition, natural language processing, emotional state estimation, prompt sentence generation, interaction with a generative AI model, and robot control.

In one embodiment, a terminal, a server, and a work robot arm cooperate to implement the invention. The terminal includes an imaging unit such as a digital camera module with an image sensor and lens, an audio input unit such as a microphone, a touch-sensitive display, a speaker, and a network interface. The terminal executes software including a camera control module using an operating system camera API (for example, an application programming interface similar to those used in common mobile platforms), an image processing library (for example, a library of functions comparable to OpenCV), an optical character recognition (OCR) component (for example, an OCR engine similar to Tesseract OCR or a platform OCR API), a user interface framework (for example, a cross-platform UI toolkit), and a local client module for acquiring facial expression image data, audio data, and operation history data.

The server includes at least one processor, a main memory, a non-transitory storage device, a network interface, and optionally a dedicated accelerator such as a graphics processing unit.

The server executes server-side software that implements an OCR service, a natural language processing module, an emotional state estimation module, a generative AI control module, a prompt sentence generation module, a display and audio guidance generation module, and a robot control module. The server may further run a web application framework and a model inference engine for executing neural network models. The work robot arm includes a plurality of joints, joint actuators, joint angle sensors, torque sensors, an end effector, and a control interface that allows the server to send motion parameters and control commands.

The terminal acquires image data of an operating manual by controlling the imaging unit through the camera API. The terminal converts raw sensor data into digital image frames and stores the frames in the terminal's memory. The terminal calls functions of the image processing library to convert a color frame into a grayscale frame, apply binarization, perform edge detection, and detect quadrilateral contours that correspond to a page region. The terminal adjusts the camera preview and overlays a guide frame so that the user can align the manual. The terminal captures a high-resolution still image when the user confirms alignment.

The terminal passes the captured image through further preprocessing. The terminal invokes functions of the image processing library to compute line segments via a Hough transform, estimate a dominant skew angle of text lines, and rotate the image to correct the skew. The terminal applies noise filtering using a median or bilateral filter to preserve edges while smoothing small artifacts. The terminal outputs a cleaned, deskewed image that improves OCR accuracy. Because the preprocessing reduces noise and normalizes alignment, the OCR engine can perform recognition with higher accuracy and at lower computational cost, thereby improving both speed and precision of character recognition.

The terminal applies OCR to the preprocessed image. The terminal provides the image data to the OCR component, which uses pattern recognition over pixel patches to detect text lines, segment characters, and assign character codes with confidence scores. The terminal gathers recognized characters and their bounding boxes, groups them into lines based on spatial proximity and baseline alignment, and reconstructs line strings. The terminal also tags lines with layout information by running regular expression matching (for example, patterns for numbered lists and headings) and simple heuristics for heading detection. The terminal produces manual structure data, for example in a hierarchical structure with page, block, line, and token entries, each annotated with text content and layout tags.

The terminal additionally acquires user-related sensor data. The terminal uses the front-facing camera to obtain facial expression image data. The terminal executes a face detection algorithm, such as a cascade classifier or a small convolutional neural network, on each captured frame, crops face regions, and resizes them to a fixed resolution. The terminal records audio data from the microphone in uniform-length segments and stores the segments as encoded digital audio. The terminal attaches event listeners to the user interface framework to log operation history data such as tap coordinates, swipe distances, and screen transition identifiers, with timestamps. The terminal encrypts all collected data using a secure protocol and transmits the manual structure data, facial expression image data, audio data, and operation history data to the server via a network connection, for example using an HTTPS session.

The server receives the transmitted data and stores it in its memory or storage. The server may optionally run an OCR service itself if the terminal only performs minimal OCR; in such variations, the server can re-run OCR or perform post-correction on recognized text using language models. The server reads the text data and layout information from the manual structure data and performs natural language processing. For languages with complex morphology, the server invokes a morphological analyzer to segment each sentence into tokens and assign part-of-speech tags. The server then builds sentence representations, such as token ID sequences or contextual embeddings produced by a transformer-based encoder (for example, a model of similar structure to known BERT-type encoders with multiple self-attention layers and feed-forward layers).

The server executes a sentence classification model on the sentence representations. The server configures the model as a neural network that takes contextual embeddings and outputs probabilities for several sentence categories, including at least procedure sentence, caution sentence, parts information sentence, and others. The server may train the classification model using supervised learning on labeled manual sentences. During training, the server defines a cross-entropy loss between predicted probabilities and reference labels, and updates model weights by backpropagation using a gradient-based optimizer. The server may apply data augmentation, for example by paraphrasing or minor text perturbations, to improve robustness. As a result, at runtime, the server can classify sentences with high accuracy even in the presence of variations in writing style.

The server organizes the classified sentences into structured data. The server uses layout cues from the manual structure data (such as numbered lines and section headings) together with sentence categories to define distinct procedure units. For each procedure, the server collects associated caution sentences, required parts, required tools, and references to figures or diagrams. The server encodes this information in a structured data object including identifiers, attributes, and relationships between steps and related information. The explicit structuring of procedures reduces ambiguity and enables later modules to address each procedure step individually.

The server estimates the emotional state of the user based on the facial expression image data, audio data, and operation history data. The server uses a convolutional neural network to process each facial expression image crop. The network may consist of multiple convolutional layers, pooling layers, and fully connected layers, trained to output probabilities over emotion labels such as calm, confused, and stressed. The server uses an acoustic feature extraction library to compute mel-frequency cepstral coefficients, pitch statistics, and energy features from the audio data, and the server supplies temporal sequences of such features to a recurrent neural network or transformer model that outputs emotion probabilities from voice.

The server extracts behavior features from operation history data, such as the number of back-navigation events and dwell times on each screen, and inputs these numeric features into a decision-tree-based or gradient-boosted model to infer interaction-based confusion or hesitation.

The server concatenates image-based, audio-based, and behavior-based features into a multimodal vector and supplies this vector to an integration network, implemented for example as a multilayer perceptron with several hidden layers. The integration network is trained using a labeled dataset of user sessions with annotated emotional states, with a loss function defined over both categorical labels (for example, calm, confused, stressed) and a continuous stress score. The server updates the network parameters during training by backpropagation. At inference time, the server uses the trained integration network to output a final emotional state label and a numeric stress level. By integrating heterogeneous features in a structured manner, the server can estimate emotional state more accurately and robustly than conventional single-modal systems.

The server retrieves user attribute information, such as skill level and language preference, from a profile database using a user identifier. The server then generates a prompt sentence for a generative AI model. The server has a library of prompt templates that encode different instruction patterns for the generative AI model. Each template may specify whether to request fine-grained steps, whether to require simple language, whether to include illustration instructions, and how to structure the output. The server selects a template based on the combination of the user's skill level and the current emotional state. The server then inserts structured procedure data into the template in a formatted textual form.

For example, when the user is a beginner and the emotional state is confused, the server may generate a prompt sentence of the following form:

“You are a professional assistant for operating manuals. Below is step information extracted from a furniture assembly manual.

The user is a beginner and is currently in a ‘CONFUSED’ state.

For this user, split the procedures into very fine-grained steps, use simple Japanese, and attach caution notes to each step.

Explicitly describe which parts should be shown in illustrations (for example, the relative position of Part A and Part B, and the insertion direction of Screw C).

Output JSON with fields ‘title’, ‘description’, ‘warning’, ‘illustration_instruction’, and ‘voice_script’ for each step.

### Original Steps:

Step 1: . . . .

Step 2: . . . ”

When the user is an advanced technician and the emotional state is calm, the server may generate a different prompt sentence:

“You are a professional assistant for operating manuals. The following step information has been extracted from an electronics repair manual.

The user is an advanced technician and is currently in a ‘CALM’ state.

For this user, remove redundant explanations and summarize only the important points in bullet form.

Always make safety-critical cautions explicit, and you may omit other minor details.

Output the steps as short one-line sentences in plain text.

### Original Steps:

Step 1: . . .

Step 2: . . . ”

When the user is frustrated and repeatedly failing at the same step, the server may generate yet another prompt sentence:

“You are a professional user-support assistant.

The user is currently in a ‘FRUSTRATED’ state and is making repeated mistakes on the same step.

Re-explain the same content in different words, as kindly and encouragingly as possible.

Include common failure examples and concrete methods to avoid them.

Also generate a voice-guide script and append it at the end of the text with the prefix ‘VOICE_SCRIPT:’.

Here is the problematic step data:

Step X: . . . ”

The server tokenizes the generated prompt sentence using the tokenizer associated with the generative AI model. The generative AI model is implemented as a transformer-based language model with multiple layers of self-attention and feed-forward sub-layers, trained on large-scale corpora of manuals and instructional texts. During model training, the server may use a language modeling objective or a sequence-to-sequence objective, with masking or teacher forcing as appropriate. The server optimizes the model's parameters with an optimizer such as Adam using backpropagation, and may use techniques such as learning rate scheduling, dropout, and layer normalization to improve generalization.

At inference time, the server sends the tokenized prompt sentence to the generative AI model through an inference engine. The generative AI model computes attention weights and hidden states across transformer layers and outputs a probability distribution over next tokens at each step. The server selects tokens using beam search or nucleus sampling to balance diversity and determinism in the output. The server then decodes the token sequence into text and parses the generated text according to the expected structure. For example, when the server requested a structured output with “title”, “description”, “warning”, “illustration_instruction”, and “voice_script” fields, the server uses a parsing routine to segment the output and assign content to each field.

The server constructs summarized procedure data from the parsed output. Each step in the summarized procedure data includes at least a title, a simplified description, a caution sentence, an illustration instruction, and an audio guidance script. The server may also annotate each step with metadata such as difficulty level or estimated time. Because the summarized procedure data is generated based on both the original manual and the user's emotional state, the steps are tailored to the user's current needs. This tailoring is achieved by modifying the prompt sentence, not by simple rule-based text truncation, so the generative AI model can perform nontrivial rephrasing and restructuring.

The server then generates display data and audio guidance data. The server converts illustration instructions into specific rendering commands, for example referencing regions of a figure or specifying shapes and colors of highlighting. The server composes a display layout that includes step-by-step panels with text elements and graphical overlays. The server attaches audio guidance scripts and associated parameters, such as speaking rate and pitch, to form audio guidance data for text-to-speech synthesis. When the emotional state indicates high stress, the server sets a slower speech rate and a more reassuring tone; when the user is calm and advanced, the server allows a faster rate and more compact explanations. These adjustments allow the system to improve clarity and reduce cognitive load for the user.

The server also sets motion parameters for the work robot arm based on the summarized procedure data and the emotional state. The server identifies which summarized steps correspond to operations that can be executed by the robot, such as inserting parts or tightening screws. The server queries a robot configuration database for the corresponding target positions, orientations, and required force or torque. The server uses a motion planning library, for example a library that implements sampling-based or optimization-based planners, to compute a collision-free trajectory that moves the robot arm's end effector from its current pose to the target pose. The server time-parameterizes the trajectory and sets maximum joint velocities and accelerations according to a baseline profile.

The server then modifies these motion parameters based on the emotional state. When the emotional state indicates confusion or stress, the server reduces velocity and acceleration limits and increases safety margins, for example by limiting how close the robot approaches the user or by adding pauses before delicate operations. When the emotional state indicates calm and the user is advanced, the server allows higher speeds and fewer pauses to improve efficiency. The server sends the motion parameters and trajectory to the robot controller through a communication interface. The robot controller executes the trajectory using its control loops, while the server monitors torque and contact forces. If sensor readings exceed thresholds, the server issues a stop command, thereby preventing unsafe conditions.

This integrated processing provides technical improvements over conventional systems. The server does not merely display text summaries; instead, the server uses structured data, multimodal emotional state estimation, and prompt-driven generative AI models to transform the internal representation of manual information and user state into machine-understandable structures. This transformation enables the server to generate context-sensitive, adaptive instructions and robot commands that would not be achievable with simple rule-based summarization. The neural network models, trained with carefully chosen loss functions and feature representations, enable robust recognition of sentence categories and emotional states, improving accuracy of classification and estimation compared to traditional methods. The structured data and prompt sentences also reduce communication overhead, because the server can transmit compact summarized data and graphical instructions to the terminal rather than entire documents.

Moreover, the system architecture improves computing efficiency by separating tasks between the terminal and the server. The terminal performs preprocessing and OCR to reduce upstream data size, while the server performs heavy-weight neural network inference and motion planning. The use of well-structured data objects for procedures and emotional states simplifies downstream processing and makes caching and incremental updates feasible. For example, when only the emotional state changes, the server can reuse previously computed structured procedure data and only regenerate prompt sentences and summarized explanations. This contributes to reduced processing latency and network bandwidth.

In alternative embodiments, the server may host different types of generative AI models, such as encoder-decoder architectures or mixture-of-experts models, and may adjust model selection based on latency or accuracy requirements. The emotional state estimation module may omit one modality, such as voice, when not available and still combine the remaining modalities. The terminal may perform partial emotional state estimation and send intermediate scores, which the server then integrates. The robot arm may be replaced by another controllable apparatus, such as a conveyor manipulator or a medical assistive device, as long as motion parameters can be set in a similar fashion.

In another variation, the server may adapt its natural language processing pipeline based on the language of the manual, choosing different morphological analyzers or parsers. The structured data representation can be extended to include additional fields, such as environmental conditions or tool calibration data, enabling further automation. The prompt templates can also be enriched to support other interaction patterns, such as question-answering modes where the generative AI model answers specific questions about a step while still respecting the user's emotional state.

By integrating these components into a coherent data flow—starting from image capture on the terminal, OCR and structuring, multimodal emotional state estimation, prompt sentence generation, generative AI model output, and robot arm control—the system provides a concrete technical solution that improves the functioning of the computer system itself. The server optimizes internal data structures for procedures and user states, increases classification accuracy, reduces processing time for repeated steps, and enables fine-grained control of physical hardware. The combination of these factors results in improved precision of instruction generation, faster adaptation to user conditions, and reduced error rates in both manual operations and automated robot tasks, thereby demonstrating a technical effect that goes beyond mere automation of human activities.

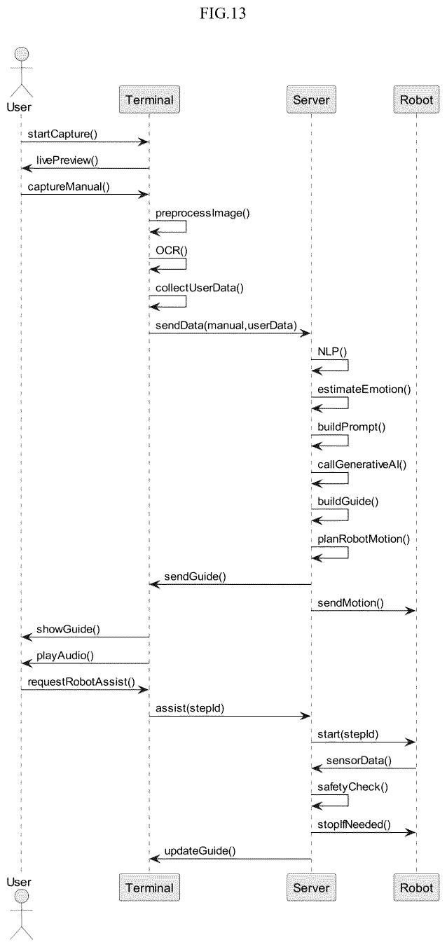

The following describes the processing flow using FIG. 13.

### Step 1:

The user operates the terminal to start manual capture.

The user taps a “Capture manual” button on a screen of the terminal.

The terminal receives this user input as an event and calls a camera control API of an operating system to activate an imaging unit.

The input to this step is a user command to start capture.

The terminal outputs a live preview stream of image frames that show the operating manual on the display.

### Step 2:

The terminal performs document detection in the live preview.

The terminal uses an image processing library to process each preview frame, detects edges and contours, and identifies a quadrilateral region corresponding to a page of the operating manual.

The terminal overlays a guide frame on the preview to indicate the detected page region.

The input to this step is the preview frame data from the imaging unit.

The terminal outputs an updated preview with a superimposed guide frame that is dynamically adjusted according to the detected contour.

### Step 3:

The user confirms alignment of the manual and triggers image capture.

The user physically adjusts the manual so that it fits within the guide frame and taps a shutter icon on the terminal display.

The terminal receives this tap event and instructs the imaging unit to capture a high-resolution still image.

The input to this step is the user tap event and the current camera configuration.

The terminal outputs a high-resolution captured image stored in memory, for example as a compressed image file.

### Step 4:

The terminal performs image preprocessing for OCR.

The terminal reads the captured image from memory and uses the image processing library to convert the image from color to grayscale, apply binarization to emphasize text, detect principal line directions by a line detection algorithm, and rotate the image to correct skew.

The terminal applies noise reduction filters to remove small artifacts and enhance character edges.

The input to this step is the raw captured image.

The terminal outputs a cleaned, deskewed image that is suitable for accurate optical character recognition.

### Step 5:

The terminal performs optical character recognition and constructs manual structure data.

The terminal applies an OCR engine to the preprocessed image, segments the image into text regions, recognizes characters, and obtains character codes and positions.

The terminal groups characters into words and lines based on spatial relationships, and it applies pattern matching to detect list numbers, headings, and captions.

The input to this step is the cleaned image.

The terminal outputs manual structure data including text strings for each line and associated layout information such as coordinates and structural tags.

### Step 6:

The terminal acquires user-related sensor data for emotional state estimation.

The terminal uses a front camera to capture facial expression image data at intervals, uses a microphone to record audio data in time segments, and records operation history data such as tap events, scroll events, and screen transitions with timestamps.

The terminal may downsample or compress these data streams to reduce size.

The input to this step is the ongoing interaction between the user and the terminal during use of the system.

The terminal outputs facial expression image data, audio data segments, and operation history data stored in buffers.

### Step 7:

The terminal packages and transmits data to the server.

The terminal creates a data packet that combines the manual structure data, the facial expression image data, the audio data, the operation history data, and user identification information.

The terminal encrypts the packet and uses a network interface to send the packet over a secure communication channel to the server.

The input to this step is the set of data generated in Steps 5 and 6, as well as stored user profile identifiers.

The terminal outputs a network request containing the encoded packet, and the server receives this packet as input for server-side processing.

### Step 8:

The server parses received data and stores it for processing.

The server receives the packet, decrypts it, and separates the manual structure data, facial expression image data, audio data, operation history data, and user attribute identifiers.

The server may store each data category in separate memory areas or databases for organized access.

The input to this step is the network packet sent from the terminal.

The server outputs structured internal representations of the manual data and user-related data, making them ready for subsequent analysis.

### Step 9:

The server performs natural language processing to generate structured procedure data.

The server takes the text and layout information from the manual structure data and runs sentence segmentation to divide text into individual sentences.

The server applies morphological analysis, syntactic parsing, and sentence classification to each sentence to determine categories such as procedure sentence, caution sentence, and parts information sentence.

The server groups related sentences and uses layout cues to form procedure steps, associating cautions and parts information with each step.

The input to this step is the manual structure data parsed in Step 8.

The server outputs structured procedure data in which each procedure step is represented by fields such as step identifier, original text, associated cautions, required parts, and required tools.

### Step 10:

The server estimates the emotional state of the user using multimodal data.

The server processes facial expression image data through an image-based model to extract facial features and compute emotion scores.

The server processes audio data through an acoustic feature extractor and a voice-based model to derive emotion indicators from speech.

The server analyzes operation history data to compute statistics related to navigation patterns and hesitation.

The server integrates these features in a multimodal model to infer an overall emotional label and a stress level.

The input to this step is the set of facial expression image data, audio data, and operation history data from Step 8.

The server outputs emotional state data, including at least an emotional label and a numeric stress score.

### Step 11:

The server retrieves user attribute information and selects a prompt template.

The server uses a user identifier to look up user attribute information such as skill level and language preference in a profile store.

The server selects a template for a prompt sentence that specifies instructions for the generative AI model, based on the combination of structured procedure data characteristics, user attribute information, and the emotional state.

The input to this step consists of structured procedure data, emotional state data, and user attribute information.

The server outputs a selected prompt template structure that defines how to instruct the generative AI model and how to format the output.

### Step 12:

The server generates a prompt sentence for the generative AI model.

The server fills the selected template with specific content, including text representing procedure steps, information about the user's skill level, and the current emotional label.

The server assembles this information into a coherent natural language instruction that describes the desired output structure and style.

The input to this step is the prompt template from Step 11 and the structured procedure data.

The server outputs a complete prompt sentence, in text form, ready to be tokenized and sent to the generative AI model.

### Step 13:

The server invokes the generative AI model to generate summarized procedure data.

The server tokenizes the prompt sentence according to a tokenizer associated with the generative AI model and sends the token sequence to an inference engine implementing a transformer-based language model.

The generative AI model processes the tokens and incrementally generates new tokens that form a summarized representation of the procedures, with fields such as title, description, warning, illustration instruction, and audio guidance script for each step.

The server decodes the generated tokens back into text and parses the text according to the expected structure.

The input to this step is the prompt sentence from Step 12.

The server outputs summarized procedure data where each step is represented in a simplified and emotionally adapted format.

### Step 14:

The server generates display data and audio guidance data based on the summarized procedure data and the emotional state.

The server analyzes illustration instructions to define how to highlight parts of figures, where to place arrows, and what colors or emphasis methods to use in the user interface.

The server selects appropriate text fragments for on-screen display and adjusts verbosity and wording according to the emotional label and stress level.

The server builds audio guidance scripts and associates each script with synthesis parameters such as speaking rate and pitch, again determined by the emotional state and user attributes.

The input to this step is summarized procedure data and emotional state data.

The server outputs display data for rendering on the terminal and audio guidance data for text-to-speech or audio playback.

### Step 15:

The server computes motion parameters for the work robot arm based on the summarized procedure data and the emotional state.

The server identifies steps that correspond to robot-executable tasks, retrieves target positions, orientations, and required force or torque for those tasks, and calls a motion planning algorithm to generate robot trajectories.

The server adjusts movement speed, acceleration, and safety margins in the motion parameters based on the user's emotional state and skill level, for example slowing down and increasing buffers when stress is high.

The input to this step is the summarized procedure data, emotional state data, and robot configuration data.

The server outputs motion parameters and trajectories that define how the work robot arm should move to perform each selected task.

### Step 16:

The server sends guidance data to the terminal and motion commands to the work robot arm.

The server packages display data and audio guidance data into a response message and transmits this message to the terminal, while also sending motion parameters and trajectories to the work robot arm via a robot control interface.

The input to this step is the display data, audio guidance data, and motion parameters computed in Steps 14 and 15.

The server outputs a network response to the terminal and control commands to the work robot arm, initiating coordinated human-machine interaction.

### Step 17:

The terminal presents visual and audio guidance to the user.

The terminal receives the display data from the server, interprets layout and graphical instructions, and renders step-by-step screens with text and highlighted diagram regions.

The terminal uses an audio engine to synthesize or play back the audio guidance scripts with the specified voice parameters.

The input to this step is the display data and audio guidance data sent by the server.

The terminal outputs visual content on the display and audible instructions through the speaker, guiding the user through each procedure step.

### Step 18:

The user performs operations while interacting with the terminal and the work robot arm.

The user follows the instructions on the display and in the audio guidance to manipulate physical components such as parts, tools, and assemblies.

The user may optionally select an on-screen control to request that the work robot arm execute a particular step.

The input to this step is the guidance presented by the terminal and the current state of the physical task.

The user outputs physical actions on the components and interaction commands to the terminal that may trigger robot assistance.

### Step 19:

The work robot arm executes motions according to motion parameters and returns sensor feedback.

The work robot arm receives motion commands from the server, moves its joints according to the specified trajectories, and performs actions such as grasping and tightening.

The work robot arm measures joint angles, torques, and contact forces and periodically sends this sensor data back to the server.

The input to this step is the motion parameters and trajectories from Step 16.

The work robot arm outputs physical motion in the real world and sensor data that indicates execution status and safety conditions.

### Step 20:

The server monitors ongoing data and updates emotional state and guidance as needed.

The server continuously receives updated facial expression image data, audio data, and operation history data from the terminal, as well as sensor data from the work robot arm, and re-runs emotional state estimation when new data suggests a change in user state.

The server, when detecting significant changes such as increased stress or confusion, may regenerate a new prompt sentence, call the generative AI model again to produce modified explanations or additional hints, and update display data, audio guidance data, and motion parameters.

The input to this step is the stream of updated multimodal data and sensor feedback.

The server outputs revised emotional state data, updated summarized procedure data when regeneration is performed, new guidance for the terminal, and adjusted control commands for the work robot arm, thereby maintaining adaptive and safe operation throughout the task.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented maintenance support systems for industrial equipment typically generate work procedures and robot control sequences based only on equipment state information or static manuals. In such systems, a server may acquire sensor data from equipment, detect an abnormal condition, retrieve a relevant portion of a manual, and then present a fixed, one-size-fits-all set of instructions to a human operator and to a robot. However, these systems do not adapt the content, structure, or safety emphasis of the generated instructions to the real-time emotional state, cognitive load, or stress level of the operator. As a result, the human-machine interface and the robot behavior are often sub-optimal for safety and efficiency.

In particular, when an operator is in a high-stress or confused state, a generative AI model that is prompted only with equipment data and manual excerpts may output instructions that are too dense, too technical, or insufficiently focused on safety. This can lead to misunderstanding, operating mistakes, and unsafe conditions, especially when a robot is executing motions at standard or high speeds near the operator. Conversely, when the operator is calm and proficient, a system that always outputs verbose, low-level instructions and always restricts the robot to conservative parameters can create unnecessary friction, reduce throughput, and waste computational and communication resources.

From a computer-technology standpoint, existing systems treat prompt generation for a generative AI model and robot control parameter selection as static or manually tuned processes. They do not exploit multimodal, real-time signals (such as facial expression, voice, biometrics, and UI interaction logs) as first-class inputs into core server-side algorithms that (i) construct and modify prompt sentences to the generative AI model, and (ii) derive context-aware robot control parameters. Thus, the computing pipeline—spanning feature extraction, emotion estimation, prompt construction, model invocation, and control synthesis—is not integrated into a feedback loop that adapts in real time to both equipment anomalies and human emotional conditions.

Accordingly, there is a need for an improved computer-implemented system and server-side processing architecture that: (1) acquires and fuses multimodal operator data to estimate an emotional state using machine learning; (2) dynamically generates and modifies prompt sentences for a generative AI model based on both equipment abnormality information and the estimated emotional state; (3) obtains from the generative AI model a structured maintenance procedure and machine operation instructions; and (4) automatically adjusts robot control parameters and human-facing presentation formats in accordance with the emotional state. Such an arrangement would improve the functioning of the computer system itself by enabling adaptive, context-aware generation and use of AI-generated instructions, leading to more robust, safer, and more efficient human-robot collaboration in industrial environments.

The specific processing by the specific processing unit 290 of the data processing device 12 in Application Example 2 is realized by the following means.

The present invention provides a server comprising a processor configured to acquire image data of an instructional document from an imaging unit, to convert character information included in the image data into machine-readable character string data, and to analyze the character string data together with equipment state information acquired from a sensor unit of an industrial facility so as to determine whether an abnormality is present in target equipment and what type of abnormality is present, and to obtain maintenance work information corresponding to the abnormality; the processor further configured to generate, based on the maintenance work information and attribute information of a worker, a prompt sentence to be input to a generative AI model, to transmit the prompt sentence to the generative AI model, and to obtain, from the generative AI model, a generation result including a maintenance work procedure and machine operation instruction information; the processor further configured to receive at least one of image information, audio information, biometric information, and operation history information of the worker, to extract multimodal features from the received information, to input the extracted features into a machine learning model, and to estimate an emotional state of the worker based on an output of the machine learning model; the processor further configured to modify a content or structure of the prompt sentence in accordance with the estimated emotional state, including dynamically adjusting at least one of a level of detail, an expression format, and an amount of safety-related information of the maintenance work procedure to be generated by the generative AI model; the processor further configured to parse the generation result, to convert, for each work step included in the generation result, information indicating a target portion, an operation type, a target position, a required tool, and a target torque or a target pressing force into robot control parameters, and to correct at least one of an operating speed, a force limit, and a degree of autonomy of a work machine having a multi-joint mechanism based on the estimated emotional state so that conservative parameters are applied under high-stress or confused conditions and more efficient parameters are applied under calm or proficient conditions; and the processor further configured to generate display data for presenting the maintenance work procedure to the worker via a display unit in a format adapted to the emotional state. This enables a computer-implemented maintenance support system to form a closed feedback loop that integrates real-time emotion estimation, adaptive prompt sentence generation for a generative AI model, and emotion-aware robot control, thereby improving the technical performance of the server-centered computing architecture in terms of safety, robustness, and operational efficiency in human-robot collaborative maintenance tasks.

The term “system” refers to a combination of hardware components and software components that cooperate to execute functions including data acquisition, data processing, interaction with a generative AI model, and control of a work machine.

The term “processor” refers to one or more hardware processing units, such as a central processing unit, a graphics processing unit, or other programmable logic, that execute instructions to perform functions including data analysis, machine learning inference, prompt sentence generation, and control signal generation.

The term “imaging unit” refers to a hardware device configured to capture image data of a physical object or document, such as a camera or an image sensor, and to output the captured image data in a digital format.

The term “image data” refers to digital data representing a captured image or sequence of images, including pixel values or encoded image formats, obtained by the imaging unit.

The term “instructional document” refers to a document that describes operations, procedures, or precautions for equipment, including but not limited to manuals, work instructions, and maintenance guides, in printed or displayed form.

The term “character information” refers to alphanumeric symbols, punctuation marks, and other textual symbols contained in the instructional document and represented in the captured image data.

The term “machine-readable character string data” refers to digital text data obtained by recognizing character information from image data, the digital text data being suitable for processing by software components such as parsers and natural language processing modules.

The term “equipment state information” refers to data that indicate an operating condition, environment condition, or abnormal condition of equipment, including sensor measurements, status codes, and diagnostic values acquired from a sensor unit.

The term “sensor unit” refers to one or more sensors and associated interfaces configured to measure physical quantities or operational states of equipment, such as temperature, vibration, current, sound, or position, and to output corresponding equipment state information.

The term “abnormality” refers to a deviation of equipment behavior or state from a normal range or expected pattern, including faults, failures, degradations, or warning conditions detected based on equipment state information.

The term “maintenance work information” refers to information describing tasks, procedures, tools, parts, and safety precautions required to correct or mitigate an abnormality, the information being obtained from one or more data sources such as manuals or databases.

The term “attribute information of a worker” refers to information indicating characteristics of a human worker, including at least one of skill level, experience level, role, language preference, or authorization, used to adapt instructions.

The term “prompt sentence” refers to an input text, command, or instruction sequence provided to a generative AI model, the input text specifying conditions, constraints, or desired formats for an output to be generated by the generative AI model.

The term “generative AI model” refers to a machine learning model, such as a neural network language model, configured to generate text or structured data based on an input prompt sentence, and trained using large volumes of training data.

The term “generation result” refers to an output produced by the generative AI model in response to a prompt sentence, the output including at least a maintenance work procedure and machine operation instruction information.

The term “maintenance work procedure” refers to an ordered set of work steps expressed in natural language or structured form, the work steps describing operations, tools, safety precautions, and conditions necessary to perform maintenance on equipment.

The term “machine operation instruction information” refers to information describing actions to be performed by a work machine, including action types, target portions, positions, tools, and force or torque parameters, in a format suitable for conversion into control commands.

The term “image information of the worker” refers to image data that include at least a part of a worker's face or body, captured for the purpose of estimating an emotional state based on visual features such as facial expressions.

The term “audio information of the worker” refers to acoustic data that include speech, breathing, or other sounds produced by a worker, captured for the purpose of estimating an emotional state based on acoustic features.

The term “biometric information” refers to data representing physiological or physical characteristics of a worker, including at least one of heart rate, heart rate variability, skin conductance, body temperature, or activity level, acquired for use in estimating an emotional state.

The term “operation history information” refers to data representing interactions of a worker with a user interface, including button presses, scrolling actions, error responses, and help requests, recorded over time to infer workload or confusion.

The term “emotional state” refers to information indicating a psychological or mental condition of a worker, including at least one of discrete emotion categories, such as calmness, stress, or confusion, and continuous indices such as a stress index.

The term “level of detail” refers to a degree of granularity of explanation in the maintenance work procedure, including how many operations are combined into a single step and how much descriptive information is included for each step.

The term “expression format” refers to a style or structure of representation used for the maintenance work procedure, including sentence length, use or avoidance of technical terms, list structures, and formatting patterns.

The term “amount of safety-related information” refers to a quantity or richness of warnings, cautions, interlocks, and environmental checks described within the maintenance work procedure.

The term “work machine having a multi-joint mechanism” refers to a machine including multiple actuated joints, such as an industrial robot arm or collaborative robot, capable of performing operations like grasping, moving, inserting, and tightening under control commands.

The term “operating speed” refers to a parameter indicating a rate of motion of the work machine, including joint velocities, path velocities, or cycle times, set by control commands.

The term “force limit” refers to a limit value imposed on a force or torque applied by the work machine during an operation, intended to restrict contact forces for safety or quality purposes.

The term “degree of autonomy” refers to a measure of how independently the work machine executes tasks, including a range from manual or step-by-step confirmation modes to continuous or fully automatic execution modes.

The term “display data” refers to structured data representing content, layout, and presentation parameters of information to be shown on a display unit, including text, step order, font size, and highlighting.

The term “display unit” refers to a hardware device capable of visually presenting information to a worker, such as a screen of a terminal, monitor, or head-mounted display.

The term “facial expression features” refers to numerical or symbolic descriptors extracted from image information of a worker's face, representing patterns of facial muscle movements associated with emotions.

The term “acoustic features” refers to numerical descriptors extracted from audio information of a worker, including pitch, energy, spectral characteristics, and prosody patterns related to emotional expression.

The term “statistical features” refers to values computed from biometric information and operation history information, such as averages, variances, counts, and rates, used as input to a machine learning model.

The term “machine learning model” refers to a computational model, such as a neural network, decision-tree ensemble, or other statistical classifier or regressor, trained using example data to map input features to outputs such as emotion categories or stress indices.

The term “emotion category” refers to a labeled class representing a type of emotional condition of a worker, such as high stress, confusion, calmness, or proficiency.

The term “stress index” refers to a numerical value representing a magnitude or intensity of stress estimated for a worker, derived by the machine learning model.

The term “step division granularity” refers to a rule or parameter defining how a maintenance work procedure is split into individual steps, including whether tasks are broken into fine-grained or coarse-grained steps.

The term “condition for permitting use of technical terms” refers to a constraint specifying when specialized terminology may be used in the maintenance work procedure output, for example depending on worker proficiency or emotional state.

The term “number of steps to be presented at one time” refers to a quantity indicating how many steps of a maintenance work procedure are concurrently shown or communicated to a worker within a single view or presentation cycle.

The term “target portion” refers to a specific part, component, or region of equipment or an object on which the work machine is intended to operate in a particular step.

The term “operation type” refers to a classification of an action to be performed by the work machine, including operations such as grasping, moving, rotating, pulling, inserting, or tightening.

The term “target position” refers to a spatial location or pose in a coordinate system at which the work machine is intended to place an end effector or tool during execution of a step.

The term “required tool” refers to a tool or attachment to be used by the work machine or the worker for a particular step, such as a gripper, screwdriver, wrench, or specialized fixture.

The term “target torque” refers to a specified torque magnitude or range to be applied by the work machine, for example when tightening a fastener.

The term “target pressing force” refers to a specified force magnitude or range to be applied by the work machine in a direction toward a workpiece, for example when inserting or clamping a component.

The term “robot control parameters” refers to values used by a control unit of a work machine to determine motion and interaction, including joint trajectories, speeds, accelerations, force limits, and mode settings.

The term “standard values” refers to default or nominal settings of operating speed, force limit, or other control parameters defined for typical operating conditions without emotional-state-based adjustment.

The term “corrected robot control parameters” refers to robot control parameters that have been modified from the standard values in response to an estimated emotional state of the worker, thereby adapting machine behavior to human conditions.

In one embodiment, a system for adaptive maintenance support includes a server, at least one terminal, and at least one work machine having a multi-joint mechanism. The server operates on a general-purpose computing platform including one or more processors, a main memory, a non-volatile storage device, and a network interface, under an operating system such as a server-class operating system. The server executes application software implemented, for example, in a high-level programming language, and uses software libraries including a database management system, a message queue system, an image processing library such as OpenCV, and a machine learning framework such as TensorFlow or PyTorch.

The terminal operates on a mobile or fixed information processing device, such as a tablet computer or a smartphone, under a mobile operating system such as a mobile device operating system. The terminal includes a display, a touch panel, a camera, a microphone, a loudspeaker, and a wireless communication interface such as a short-range communication module and a wireless local network module. The terminal executes a dedicated application developed, for example, with a standard mobile development environment.

The work machine includes an industrial robot or a collaborative robot having a multi-joint mechanism, a robot controller, and sensors such as joint encoders and force/torque sensors.

The robot controller executes robot control software or robot middleware, for example a robot operating framework, and communicates with the server over an industrial network.

The server acquires image data of an instructional document from an imaging unit. In one example, the instructional document is a paper maintenance manual placed under a document camera connected to the server, or a manual displayed on a screen and captured by a camera.

The server applies an optical character recognition process to the image data using an OCR engine to convert character information into machine-readable character string data. The server stores the character string data in a text repository managed by a database management system.

The server acquires equipment state information from a sensor unit installed on industrial equipment. The sensor unit generates time-series measurements such as temperature, vibration, current, and sound pressure. The server receives the measurements via a protocol such as MQTT or HTTP and stores the data in a time-series database. The server normalizes the data, aligns timestamps, and extracts features such as rolling means, spectral components, and statistical deviations. The server applies an anomaly-detection algorithm implemented in a machine learning framework. In one example, the server uses an autoencoder neural network consisting of several fully connected layers with nonlinear activation functions. The server trains the autoencoder in advance on normal operation data using a reconstruction error loss function and gradient-based weight updates such as stochastic gradient descent or an adaptive optimizer. During operation, the server feeds preprocessed sensor features into the trained autoencoder, computes a reconstruction error, and compares the error with a threshold stored in configuration data. If the reconstruction error exceeds the threshold, the server determines that an abnormality is present and further applies a classifier model to assign an abnormality type, such as bearing wear or motor overheating.

The server retrieves maintenance work information corresponding to the abnormality type by querying a maintenance database that stores instructional documents, parts lists, and standard procedures. The server uses text indexing and full-text search to identify relevant sections of the manuals and extracts paragraphs that describe the maintenance steps, required tools, and safety precautions for the abnormality. The server associates the extracted text with identifiers of the target equipment and target parts.

The terminal presents to a user a user interface for starting maintenance tasks. The user selects a target equipment identifier on the display and initiates a maintenance session by touching a start control. The terminal transmits the selected equipment identifier and a worker identifier to the server over the network.

The terminal acquires image information, audio information, biometric information, and operation history information of the user. The terminal controls the camera to capture frames including the face of the user and performs local preprocessing, such as cropping and resizing, before sending the image frames to the server. The terminal records audio using the microphone, converts the audio to a standard format, and transmits the audio data to the server. The terminal obtains biometric signals such as heart rate from a wearable device via short-range communication and embeds these values into periodic biometric reports. The terminal records operation history information such as button presses, scrolling events, help requests, and error-dialog interactions with timestamps and sends the log entries to the server.

The server estimates an emotional state of the user by applying multimodal machine learning.

The server uses an image processing library to detect a face region in each frame and to compute facial expression features, such as distances between key facial landmarks and muscle activation indicators. The server computes acoustic features from audio data, such as pitch contours, energy envelopes, spectral shape, and speaking rate, using an audio signal processing library. The server calculates statistical features from biometric and operation history information, including average heart rate, heart rate variability, frequency of help-button activations, and duration of pauses in interaction.

The server concatenates the extracted features into a feature vector and inputs the feature vector into a trained machine learning model for emotion estimation. In one embodiment, the model is a neural network constructed as a multi-branch architecture: one convolutional subnetwork processes facial features, one recurrent or temporal convolutional subnetwork processes acoustic features, and one fully connected subnetwork processes biometric and behavioral statistics. The server merges the outputs of the branches in a fusion layer and outputs both a discrete emotion category, such as “high stress and confusion” or “calm and proficient,” and a continuous stress index. The server trains this model off-line using supervised learning with labeled data, where ground-truth labels are assigned based on psychological assessments or controlled tasks. The server uses a loss function that combines cross-entropy for the emotion category and mean-squared error for the stress index and updates weights using gradient-based optimization.

The server uses the estimated emotional state to control both the construction of a prompt sentence for a generative AI model and the adjustment of control parameters for the work machine. The server generates a prompt sentence by filling a text template with parameters including the abnormality type, the target part, the extracted maintenance text, and instruction clauses that depend on the emotion category and stress index. The server uses string concatenation and formatting functions to assemble the prompt sentence.

In one example for a high-stress user, the server generates the following prompt sentence:

“You are an expert in factory machine maintenance.

Based on the following repair manual, describe in Japanese the procedure to repair an abnormality caused by bearing wear in a motor.

The user is currently estimated to be in a ‘high-stress and confusion’ state.

Therefore,
split the procedure into fine-grained steps,
use short and simple sentences,
avoid technical terms as much as possible, and
include at least one explicit safety warning in every step.

Furthermore, because this procedure will be converted into a format executable by a robotic arm,
for each step, explicitly specify ‘target part,’ ‘action content (for example, grasp, turn, remove, attach),’ ‘required tool,’ ‘force level (torque or pressing force),’ and ‘safety condition.’
   [Excerpt from Repair Manual]

---

(insert bearing replacement text here)

---”

In another example for a calm, proficient user, the server generates the following prompt sentence:

“You are an expert in factory machine maintenance.

Based on the following manual, concisely summarize in Japanese the procedure to repair an abnormality caused by bearing wear in a motor.

The user is currently estimated to be ‘calm’ and experienced. Therefore,
list only the key steps,
you may use technical terms, and
you may present multiple steps at once.

Also, assuming that each step will be automatically executed by a robotic arm,
for each step, specify the required robot action (for example, tighten four bolts with the specified torque) as imperative commands.
   [Excerpt from Repair Manual]

---

(insert bearing replacement text here)

---”

The server sends the prompt sentence to a generative AI model via an application programming interface exposed by a model server. The generative AI model is implemented as a large-scale neural network, for example a transformer-based language model with multiple self-attention layers, trained on large corpora of technical and general text. During inference, the model processes the tokenized prompt using attention mechanisms and produces an output sequence token by token. The server sets model parameters such as maximum output length, sampling temperature, and output format hints in the API request.

The server receives the generation result from the generative AI model and parses it into structured data. When the prompt sentence instructs the model to output stepwise information with labeled fields, the server uses parsing rules or pattern matching to extract, for each step, a human-readable description, a target portion identifier, an operation type, a required tool, a target torque or pressing force, and a safety condition. The server stores this structured representation in a database and maps part names and tool names to internal codes using lookup tables.

The server derives robot control parameters from the structured data. The server uses kinematic and dynamic models associated with the work machine to convert target positions and operation types into joint trajectories and force profiles. The server applies constraint algorithms to ensure that the target torque and force limits specified by the generation result are respected. The server then adjusts these parameters based on the emotional state. When the emotional state indicates high stress or confusion, the server multiplies nominal velocity and acceleration limits by a safety factor less than one, and reduces force limits to create a safe motion profile around the user. When the emotional state indicates calmness and proficiency, the server allows higher velocities and a higher degree of autonomy, such as automatically executing several steps without waiting for step-by-step confirmation, while maintaining safety constraints defined in configuration data.

The server transmits the resulting control commands to the robot controller through a robot communication interface. The robot controller executes these commands at a deterministic control cycle, interpolating joint trajectories and applying force control algorithms. The robot controller feeds back sensor readings, such as joint positions and forces, to the server. The server monitors these readings and detects anomalies in robot behavior, such as over-torque or unexpected contact, by evaluating thresholds and applying statistical checks. If an anomaly is detected, the server issues an emergency stop command and notifies the terminal.

The server generates display data for presenting the maintenance work procedure to the user.

The server determines a presentation style based on the emotional state. For a high-stress state, the server constructs display data that contain one step per screen, uses large fonts, and adds prominent safety warnings as separate fields. For a calm, proficient state, the server constructs display data that show multiple steps in a list, with the ability for the user to expand steps for more details. The server sends the display data to the terminal.

The terminal receives the display data and renders the content on the display. The terminal adjusts fonts, colors, and layout according to style parameters included in the display data.

The terminal may also invoke a text-to-speech component to read out each step and warning.

The user follows the instructions, may command the robot through the terminal, and may request help or pause the process. The terminal records such interactions in the operation history information, which the server uses as additional input for subsequent emotion estimation, thereby closing a feedback loop.

From a computer-technology perspective, this embodiment provides specific improvements over conventional static systems. Because the server uses multimodal features and a trained fusion model to compute an emotional state, and uses that state to alter the structure and semantics of the prompt sentence as well as robot control parameters, the server adaptively changes its internal processing rather than merely automating a fixed manual. The combination of autoencoder-based equipment anomaly detection, multimodal emotion estimation, and transformer-based generative AI in one pipeline increases the relevance and safety of generated instructions. The server reduces communication load by adjusting the number of steps presented at a time and by caching emotion states, and improves computational efficiency by reusing extracted features across multiple estimation cycles.

The server improves accuracy and robustness of maintenance procedures because the generative AI model receives context-rich prompt sentences that encode both technical abnormality details and human state constraints. This results in generation results that are structurally aligned with robot control needs, reducing post-processing complexity and error rates in mapping instructions to control commands. By explicitly generating torque and force parameters, the server reduces the need for conservative fixed safety margins and enables more precise control, which in turn reduces mechanical stress on equipment.

The server employs non-conventional rules and procedures, such as altering prompt sentence content based on emotion category and stress index, and correcting robot control parameters as a function of human emotional state. These rules are implemented as algorithmic decision logic inside the server and are not conventional in static maintenance systems. As a result, the server changes how the computing architecture operates: the same generative AI model and robot hardware are driven by a novel, state-dependent control of prompts and parameters that yields technical effects including reduced misinterpretations, faster convergence to appropriate maintenance plans, and lower incidence of unsafe motions.

In alternative embodiments, the server may employ different neural network architectures, such as graph neural networks for representing equipment structures, or may use different training methods, such as self-supervised pretraining for emotion estimation features. The server may also implement different optimization objectives, such as multi-objective loss functions that balance human comprehension metrics and robot energy consumption. The terminal may be implemented as a head-mounted display to present augmented-reality overlays aligned with physical components, while still using the same prompt sentence generation and emotion-aware control logic on the server. The work machine may be a mobile platform or a gantry system instead of a traditional articulated arm, with the server converting the machine operation instruction information into appropriate control parameters for those machines.

In another variation, the server may locally host the generative AI model instead of accessing it via a network, thereby reducing network latency and external dependence. The server may store past prompt sentences, generation results, and outcome metrics in a history repository and perform offline analysis to update templates and thresholds, further optimizing the pipeline. In all of these embodiments, the server, the terminal, and the work machine cooperate to implement a concrete technical solution that improves the functioning of the computer-based maintenance support system itself, rather than merely computerizing manual procedures.

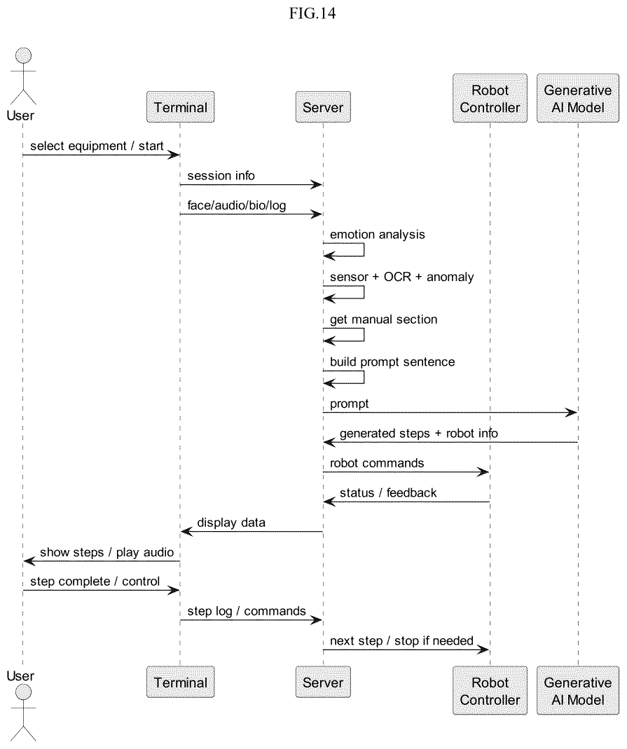

The following describes the processing flow using FIG. 14.

### Step 1:

The server acquires, as input, raw image data of an instructional document from an imaging unit and raw equipment state data from a sensor unit. The server performs optical character recognition on the image data using an OCR engine to convert pixel values into machine-readable character string data, and performs time-series preprocessing on the equipment state data, including timestamp alignment, noise filtering, and normalization. The server outputs cleaned character string data representing the instructional document and preprocessed sensor data representing the equipment state.

### Step 2:

The server takes, as input, the preprocessed sensor data from Step 1 and executes an anomaly-detection algorithm implemented in a machine learning framework. The server feeds the sensor features into a trained anomaly-detection model, computes reconstruction errors or anomaly scores, and compares the scores against stored thresholds. Based on these computations, the server outputs an abnormality determination (“normal” or “abnormal”) and, when abnormal, an abnormality type label associated with the target equipment.

### Step 3:

The server receives, as input, the abnormality type label, an equipment identifier, and the character string data of the instructional document. The server queries a maintenance database using the abnormality type and equipment identifier as keys, performs full-text search over the stored documents, and extracts relevant sections that describe maintenance procedures, tools, and safety precautions. The server outputs maintenance work information including a target portion description, procedure text excerpts, and associated metadata.

### Step 4:

The terminal presents, as input to the user, a graphical interface listing available equipment.

The user selects a target equipment and initiates a maintenance session by touching a start control on the display. The terminal records the user selection and session start as data including a user identifier and an equipment identifier. The terminal outputs this session initiation data to the server via a network connection.

### Step 5:

The terminal acquires, as input, sensor streams from local devices including the camera, microphone, and a connected wearable device, and interaction events from the user interface.

The terminal captures image frames of the user's face, records audio segments of the user's voice, receives biometric values such as heart rate, and logs UI events such as button presses and scroll actions with timestamps. The terminal performs local preprocessing, including cropping face regions from images, encoding audio in a standard format, and packaging biometric and log data. The terminal outputs processed image information, audio information, biometric information, and operation history information to the server.

### Step 6:

The server takes, as input, the multimodal data from Step 5. The server applies image processing to the image information to detect facial regions and extract facial expression features, and applies audio signal processing to the audio information to compute acoustic features such as pitch and energy. The server calculates statistical features from the biometric information and operation history information, including averages, variances, and event counts. The server concatenates these feature sets into an emotion feature vector and feeds the vector into a trained emotion-estimation neural network. The server executes forward propagation, obtains output probabilities for emotion categories and a numerical stress index, and outputs an estimated emotional state for the user.

### Step 7:

The server receives, as input, the maintenance work information from Step 3, the abnormality type label from Step 2, and the emotional state from Step 6, along with stored attribute information of the user. The server selects a prompt template based on the abnormality type and user attributes, and inserts into the template the abnormality description, target portion description, relevant manual excerpts, and emotion-dependent instruction clauses. The server performs string concatenation and formatting operations to construct a coherent prompt sentence tailored to the emotional state, and outputs the completed prompt sentence as text.

### Step 8:

The server sends, as input to a generative AI model, the prompt sentence from Step 7 through an API request. The server receives as output from the generative AI model a generation result in natural language that includes a stepwise maintenance work procedure and embedded descriptions of machine operation instructions. The server parses the generation result by applying pattern-matching rules or structured output parsing, segments the result into discrete steps, and extracts for each step a human-readable instruction, a target portion, an operation type, a required tool, a target torque or pressing force, and a safety condition. The server outputs structured human-oriented procedure data and structured machine-operation instruction data.

### Step 9:

The server takes, as input, the machine-operation instruction data from Step 8 and the estimated emotional state from Step 6. The server converts, for each step, the target portion and operation type into robot kinematic targets and action codes, and maps the required tool and force parameters to internal control parameters compatible with the robot controller. The server then modifies operating speed limits, acceleration limits, and force limits based on the emotional state, applying lower values for high stress or confusion and higher values within safety bounds for calmness or proficiency. The server outputs robot control command sequences including joint trajectories, velocity profiles, and force constraints.

### Step 10:

The server sends, as input to the robot controller, the robot control command sequences from Step 9. The robot controller executes the commands on the work machine, moving its joints and applying forces according to the specified trajectories and limits. The server receives feedback data from the robot controller, including joint positions, torques, and force-sensor readings. The server evaluates the feedback against expected ranges and thresholds, detects any abnormal robot behavior, and, if necessary, outputs emergency stop commands and error notifications.

### Step 11:

The server takes, as input, the human-oriented procedure data from Step 8 and the emotional state from Step 6. The server determines a presentation style, including step grouping, font size, and the amount of safety information to emphasize, according to the emotional state. The server builds display data structures containing text for each step, step ordering, safety warnings, and layout hints such as the number of steps per screen. The server outputs the generated display data to the terminal.

### Step 12:

The terminal receives, as input, the display data from Step 11. The terminal renders the maintenance work procedure on the display, arranging steps, safety notes, and navigation controls according to the layout hints. The terminal may simultaneously send each step's text to a text-to-speech engine to synthesize audio guidance and outputs the resulting audio through the loudspeaker. The user observes the displayed instructions, listens to the audio, and performs physical maintenance operations on the equipment, such as turning off power, removing covers, and replacing components. After completing each step, the user interacts with the terminal, for example by tapping a “Next” button, and the terminal outputs step-completion events back to the server, which are then used to synchronize ongoing robot actions and to update logs for future analysis.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

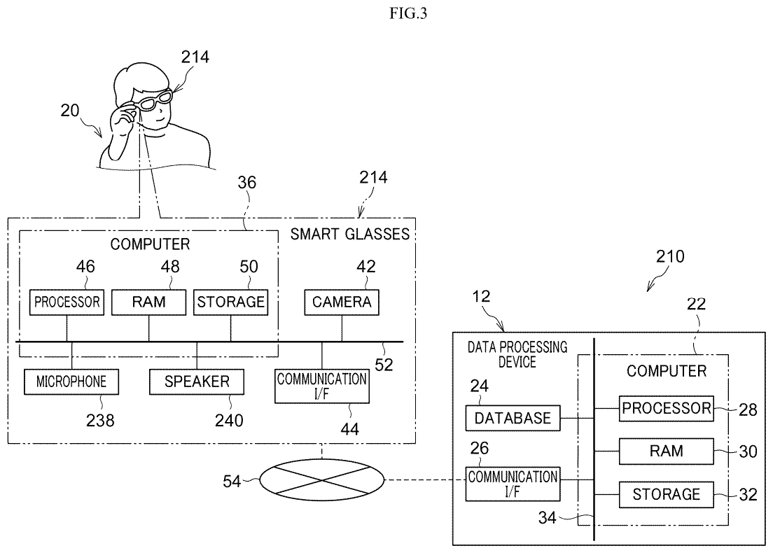

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

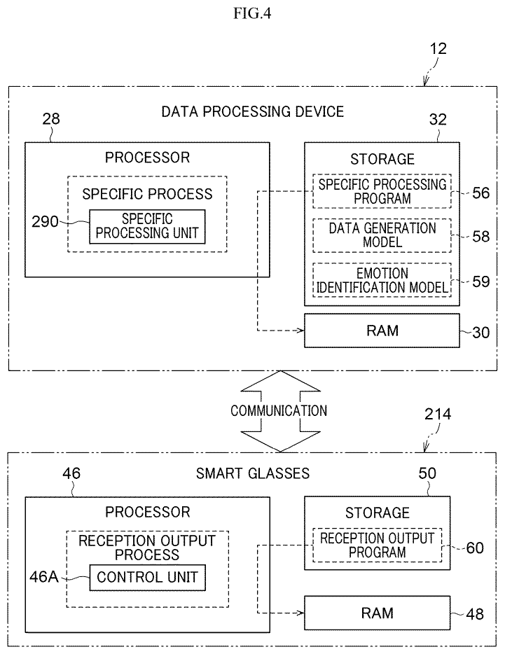

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

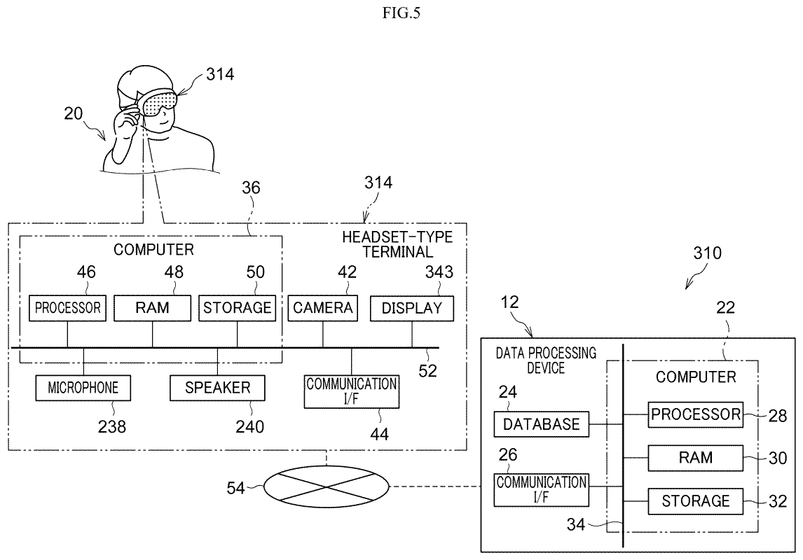

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

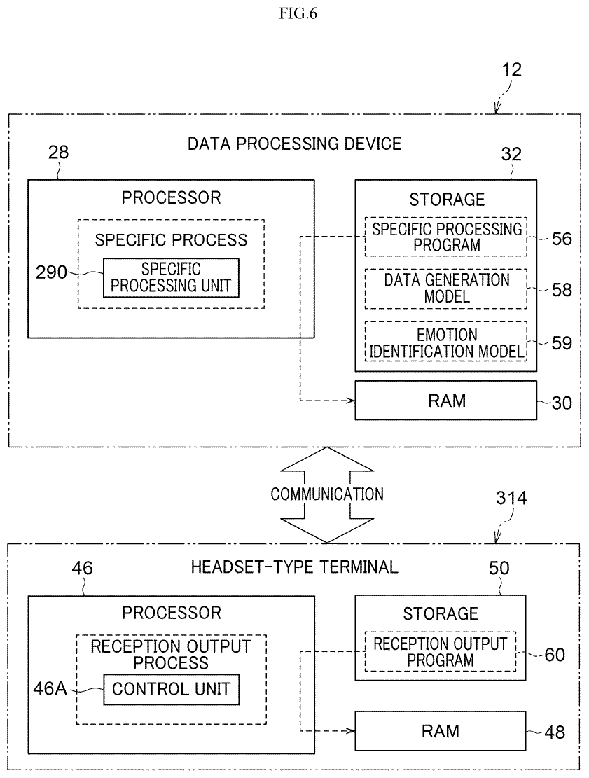

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

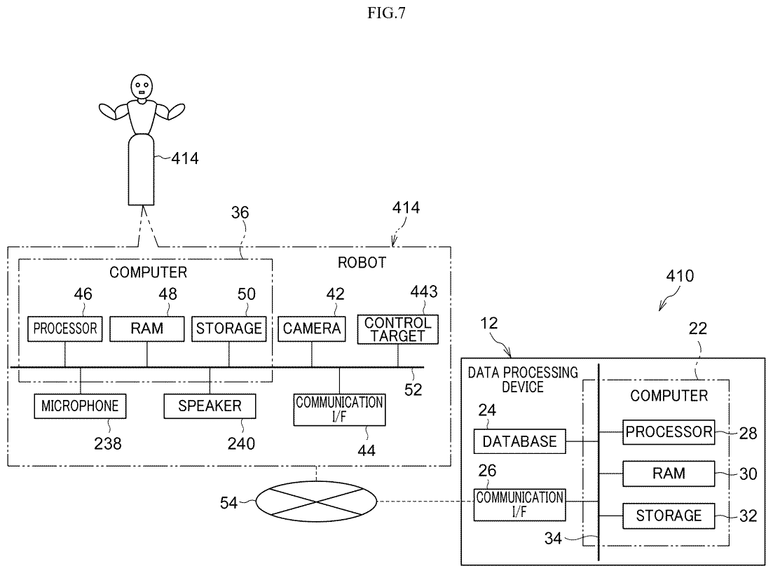

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

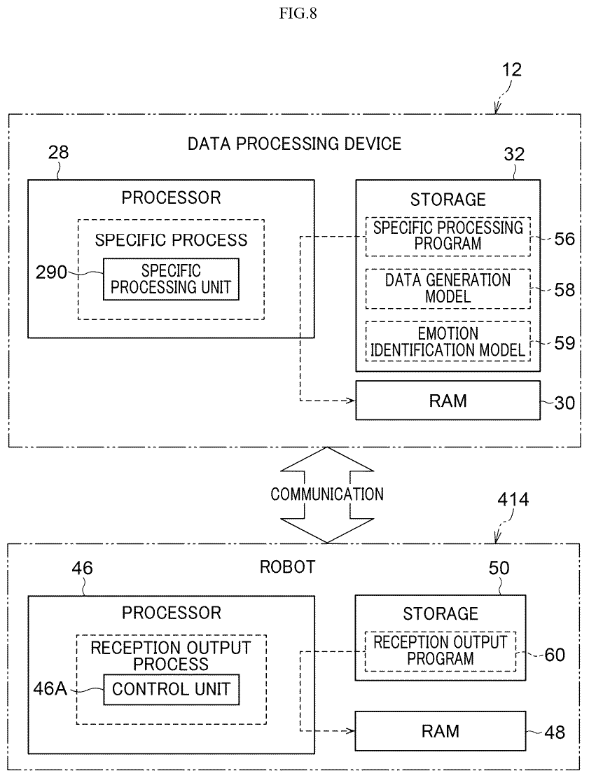

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

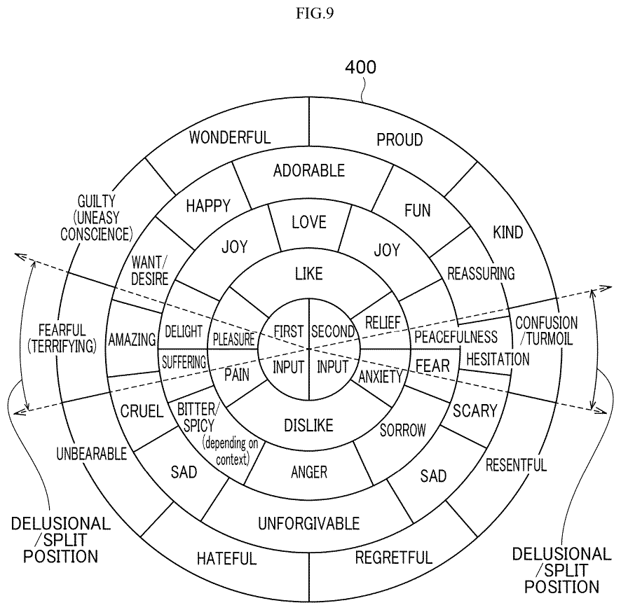

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

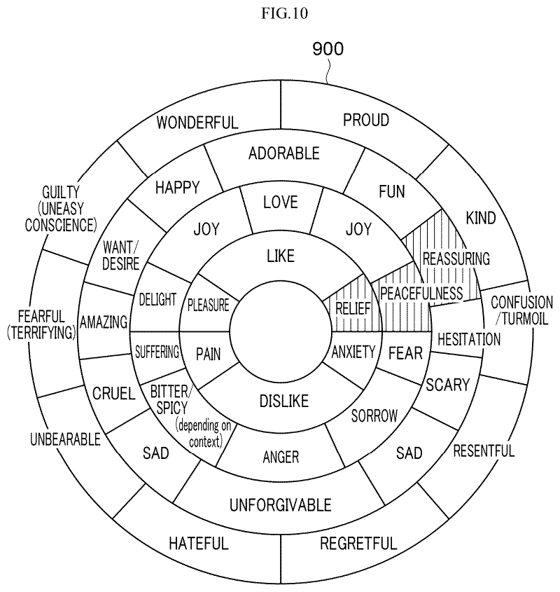

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire image information including description information recorded on an information recording medium by using an image capturing device operated by a user, and perform preprocessing on the image information and execute optical character recognition processing on the preprocessed image information so as to extract character information and convert the character information into machine-readable character string data, and
execute natural language processing on the character string data to segment the character string data into units of sentences and words, perform syntactic analysis and semantic analysis on the segmented data, and extract task procedure information, caution information, component information, and tool information, and generate structured data representing the extracted information, and
generate a prompt sentence for input to a generative information processing model on the basis of the structured data and context information including user attribute information, execute the generative information processing model using the prompt sentence and the structured data as inputs, and generate procedure data in which a task procedure is summarized as a sequence of steps and which includes, for each step, warning information and illustration metadata, and
identify, on the basis of the procedure data, steps that are executable by an automated multi-joint work mechanism, and generate a low-level operation sequence including grasping operations, positioning operations, and fastening operations in accordance with an identification result, and
perform kinematic calculation and trajectory planning calculation on the low-level operation sequence so as to generate joint command values, position command values, and force command values for the multi-joint work mechanism in time order, and transmit the joint command values, the position command values, and the force command values to the multi-joint work mechanism so as to control the multi-joint work mechanism, and
acquire position detection information, force detection information, and image detection information from the multi-joint work mechanism, generate correction commands on the basis of deviations between the position detection information and the position command values and between the position detection information and the joint command values, and stop an operation of the multi-joint work mechanism when an abnormal state is detected, and
generate presentation data for transmission to a user terminal, the presentation data being configured to cause the user terminal to perform visual presentation of the procedure data in a step-by-step format and to perform audio guidance based on the procedure data, and
generate and transmit an additional prompt sentence to the generative information processing model so as to regenerate and update at least a part of the procedure data in response to a user request for increasing or decreasing a level of detail, and update the presentation data on the basis of regenerated procedure data.

### (Supplementary 2)

The system according to supplementary 1,
wherein the processor is configured to
execute, in the natural language processing, classification processing and labeling processing on the character string data so as to automatically classify each sentence into at least one of a procedure category, a warning category, a tool requirement category, and a note category, execute term conversion processing that converts technical terms into generic expressions, and include, in the prompt sentence for the generative information processing model, constraint conditions that explicitly specify an output format, a detail level, a language level, and a display style for warning information.

### (Supplementary 3)

The system according to supplementary 1,
wherein the processor is configured to
associate each step in the procedure data with at least one operation template selected from a transport operation template for grasping and conveying a component, a fastening operation template for fastening a fastening member with a predetermined torque, and an alignment operation template for positioning components relative to each other, execute the kinematic calculation and the trajectory planning calculation on the basis of an association result, and correct, in real time, parameters of the operation template on the basis of the image detection information and the force detection information acquired from the multi-joint work mechanism.

### Application Example 1

### (Supplementary 1)

A system comprising a processor,
wherein the processor is configured to
acquire printed information by controlling an imaging unit,
convert the acquired printed information into electronic information including character information by executing a character recognition process,
acquire operation state information as time-series information from multiple state detection elements provided for multiple apparatuses, and store the operation state information in a storage,
analyze the stored operation state information to determine presence or absence of an abnormal state and to estimate a cause of the abnormal state,
extract procedure information and caution information related to the estimated cause of the abnormal state on the basis of the electronic information obtained by the character recognition process and a result of the analysis, by executing a natural language information extraction process,
generate a prompt sentence in a predetermined format including the procedure information and the caution information, input the prompt sentence and the procedure information to a generative AI model, and acquire output information from the generative AI model, the output information including a work procedure executable by an automatic work mechanism, by executing a generative-AI cooperation process,
convert the work procedure into a sequence of basic actions including at least a grasping action, a positioning action, a fastening action, and an inserting action, add correction information based on position information and force information of an object to be handled, and generate motion planning information by executing a motion-planning generation process,
drive the automatic work mechanism on the basis of the motion planning information by executing a work-mechanism drive process,
acquire joint position information, force information, and external detection information of the automatic work mechanism, apply real-time correction to the motion planning information, and perform safety stop control and restart control of the automatic work mechanism by executing an operation control process, and
cause a display and input interface to present abnormal condition information, work procedure information, and progress information generated by the analysis and the generative-AI cooperation process, receive from a user an instruction including at least one of approval of a work plan, a change of a parameter, and a stop command, and reflect the instruction in the motion-planning generation process and the operation control process, by executing a display and input control process.

### (Supplementary 2)

The system according to supplementary 1,
wherein the processor is configured to
generate, in the generative-AI cooperation process, the prompt sentence automatically by using context information including at least the estimated cause of the abnormal state, a type of a target apparatus, performance constraints of the automatic work mechanism, and safety conditions,
insert into the prompt sentence a description requesting a structured output format including step numbers, target portions, tools to be used, allowable torque values, required time, and safety confirmation items,
obtain, from the generative AI model, the output information as machine-readable hierarchical structure data conforming to the structured output format, and
supply the hierarchical structure data to the motion-planning generation process.

### (Supplementary 3)

The system according to supplementary 1,
wherein the processor is configured to
accumulate past abnormal state information, work history information, and work result information in the storage,
analyze trends of abnormal state occurrence and work time on the basis of the accumulated information,
automatically update constraint conditions, required accuracy, and safety procedure descriptions included in the prompt sentence in accordance with a result of the analysis, and
optimize content and order of the work procedure obtained from the generative AI model by a learning-based method.

### Example 2

### (Supplementary 1)

A system comprising a processor,
wherein the processor is configured to
acquire image data of an operating manual by controlling an imaging unit,
perform optical character recognition on the image data to generate text data and layout information of the operating manual,
perform natural language processing on the text data and the layout information to generate structured data including procedure information and caution information,
estimate an emotional state of a user based on at least one of facial expression image data, audio data, and operation history data of the user,
generate a prompt sentence to be input to a generative AI model, based on the structured data, user attribute information, and the emotional state,
cause the generative AI model to generate summarized procedure data corresponding to the procedure information by inputting the prompt sentence to the generative AI model,
generate display data and audio guidance data according to the summarized procedure data and the emotional state, and control an information presentation device based on the display data and the audio guidance data,
set motion parameters of a work robot arm according to a work content included in the summarized procedure data and according to the emotional state, and control operation of the work robot arm based on the motion parameters.

### (Supplementary 2)

The system according to supplementary 1,
wherein the processor is configured to
perform sentence segmentation, morphological analysis, syntactic analysis, and sentence classification on the text data,
classify sentences of the operating manual into at least a procedure sentence, a caution sentence, and a parts information sentence,
generate structured procedure data in which, for each procedure, required parts, required tools, and related caution information are assigned as attributes,
generate the prompt sentence so as to include an instruction, in accordance with the structured procedure data, the user attribute information, and the emotional state, regarding at least a degree of subdivision of the procedure, simplification of technical terms, presence or absence of illustration instruction, presence or absence of an audio guidance script, and an output format, and
cause the generative AI model to generate, as the summarized procedure data, data in which each procedure includes at least a title, a description sentence, a caution sentence, an illustration instruction, and an audio guidance script.

### (Supplementary 3)

The system according to supplementary 1,
wherein the processor is configured to
perform image feature extraction processing on the facial expression image data, acoustic feature extraction processing on the audio data, and behavior feature extraction processing on the operation history data,
input the extracted features into a machine learning model to estimate the emotional state including at least a calm state, a confused state, and a stressed state,
change at least one of a motion speed, an acceleration, a safety margin, and a degree of automation of the work robot arm according to the emotional state, and
slow down or temporarily stop the operation of the work robot arm when the emotional state indicates a stress level exceeding a predetermined threshold.

### Application Example 2

### (Supplementary 1)

A system comprising a processor,
wherein the processor is configured to acquire, from an imaging unit, image data of an instructional document and convert character information included in the image data into machine-readable character string data,
wherein the processor is configured to analyze, based on the character string data and equipment state information acquired from a sensor unit of an industrial facility, whether an abnormality is present in target equipment and what type of abnormality is present, and to obtain maintenance work information corresponding to the abnormality,
wherein the processor is configured to generate a prompt sentence to be input to a generative AI model, the prompt sentence being generated based on the maintenance work information and on attribute information of a worker, and to obtain, from the generative AI model, a generation result including a maintenance work procedure and machine operation instruction information,
wherein the processor is configured to estimate an emotional state of the worker based on at least one of image information, audio information, biometric information, and operation history information of the worker,
wherein the processor is configured to modify a content or structure of the prompt sentence to be transmitted to the generative AI model in accordance with the emotional state, and to dynamically adjust at least one of a level of detail, an expression format, and an amount of safety-related information of the maintenance work procedure included in the generation result,
wherein the processor is configured to, based on the machine operation instruction information included in the generation result and the emotional state, control a work machine having a multi-joint mechanism by changing at least one of an operating speed, a force limit, and a degree of autonomy of the work machine, and
wherein the processor is configured to generate display data for presenting the maintenance work procedure to the worker via a display unit.

### (Supplementary 2)

The system according to supplementary 1,
wherein the processor is configured to extract facial expression features from the image information, to extract acoustic features from the audio information, to calculate statistical features from the biometric information and the operation history information, to input the extracted and calculated features into a machine learning model, and to estimate, as the emotional state, an emotion category and a stress index, and
wherein the processor is configured to add, to the prompt sentence, instruction text that specifies at least one of a step division granularity of the maintenance work procedure, a condition for permitting use of technical terms, a number of steps to be presented at one time, and an amount of safety-related information to be included in each step, in accordance with the estimated emotion category and the stress index.

### (Supplementary 3)

The system according to supplementary 1,
wherein the processor is configured to convert, for each work step included in the generation result, information indicating a target portion, an operation type, a target position, a required tool, and a target torque or a target pressing force into robot control parameters, and
wherein the processor is configured to, when the emotional state indicates high stress or confusion, set the robot control parameters such that the operating speed and the force limit are lower than standard values, and to, when the emotional state indicates calmness or proficiency, correct the robot control parameters such that at least one of the operating speed and the degree of autonomy is increased, and to control the work machine based on the corrected robot control parameters.

What is claimed is:

1. A system comprising:
circuitry configured to:
acquire, via a communication interface coupled to a packet-switched network, image data from an image capturing device, perform preprocessing on the image data, and execute optical character recognition processing on the preprocessed image data to extract character information and convert the character information into machine-readable character string data;
execute natural language processing on the character string data to segment the character string data into units of sentences and words, perform syntactic analysis and semantic analysis on the segmented data, and extract task procedure information, component information, and tool information, and generate structured data representing the extracted information;
generate a prompt sentence for input to a generative information processing model on the basis of the structured data and context information, execute the generative information processing model using the prompt sentence and the structured data as inputs, and generate procedure data in which a task procedure is represented as a sequence of steps;
identify, on the basis of the procedure data, steps that are executable by an automated multi-joint work mechanism, and generate a low-level operation sequence comprising grasping operations, positioning operations, and fastening operations;
perform kinematic calculation and trajectory planning calculation on the low-level operation sequence to generate joint command values, position command values, and force command values in time order, and transmit the joint command values, the position command values, and the force command values to the multi-joint work mechanism via the packet-switched network; and
acquire position detection information, force detection information, and image detection information from the multi-joint work mechanism, generate correction commands on the basis of deviations between the detection information and the command values, and transmit updated command values to the multi-joint work mechanism.

2. The system according to claim 1, wherein the circuitry is configured to execute the natural language processing by performing sentence segmentation, morphological analysis, and sentence classification on the character string data to classify each sentence into at least one of a procedure category, a warning category, a tool requirement category, and a note category.

3. The system according to claim 2, wherein the circuitry is configured to generate the structured data in which, for each classified procedure, required components, required tools, and related warning information are assigned as attributes.

4. The system according to claim 3, wherein the circuitry is configured to generate the prompt sentence to include constraint conditions that specify at least an output format, a detail level, a language level, and a display style for the procedure data, based on the structured data and user attribute information.

5. The system according to claim 4, wherein the circuitry is configured to cause the generative information processing model to generate the procedure data in which each step includes at least a title, a description sentence, a warning sentence, an illustration instruction, and an audio guidance script.

6. The system according to claim 1, wherein the circuitry is configured to associate each step in the procedure data with at least one operation template selected from a transport operation template for grasping and conveying a component, a fastening operation template for fastening a fastening member with a predetermined torque, and an alignment operation template for positioning components relative to each other.

7. The system according to claim 6, wherein the circuitry is configured to correct, in real time, parameters of the operation template on the basis of the image detection information and the force detection information acquired from the multi-joint work mechanism.

8. The system according to claim 7, wherein the circuitry is configured to stop an operation of the multi-joint work mechanism when a deviation between the position detection information and the position command values exceeds a predetermined safety threshold, and to resume the operation after receiving a restart instruction via the packet-switched network.

9. The system according to claim 1, wherein the circuitry is configured to perform the preprocessing on the image data by applying at least one of binarization processing, noise removal processing, tilt correction processing, and contrast enhancement processing.

10. The system according to claim 1, wherein the circuitry is configured to estimate an emotional state of a user based on at least one of facial expression image data, audio data, and operation history data of the user, and to include the estimated emotional state in the context information used to generate the prompt sentence.

11. The system according to claim 10, wherein the circuitry is configured to perform image feature extraction processing on the facial expression image data, acoustic feature extraction processing on the audio data, and behavior feature extraction processing on the operation history data, and to input the extracted features into a machine learning model to estimate the emotional state as at least one of a calm state, a confused state, and a stressed state.

12. The system according to claim 11, wherein the circuitry is configured to change at least one of a motion speed, an acceleration, a safety margin, and a degree of automation of the multi-joint work mechanism according to the estimated emotional state, and to temporarily stop the operation of the multi-joint work mechanism when the emotional state indicates a stress level exceeding a predetermined threshold.

13. The system according to claim 1, wherein the circuitry is configured to generate presentation data for transmission to a user terminal via the packet-switched network, the presentation data being configured to cause the user terminal to perform visual presentation of the procedure data in a step-by-step format and to perform audio guidance based on the procedure data.

14. The system according to claim 13, wherein the circuitry is configured to generate and transmit an additional prompt sentence to the generative information processing model so as to regenerate and update at least a part of the procedure data in response to a user request for increasing or decreasing a level of detail, and to update the presentation data on the basis of regenerated procedure data.

15. The system according to claim 1, wherein the circuitry is configured to accumulate past operation result information and work history information in a storage, analyze trends on the basis of the accumulated information, and automatically update constraint conditions and safety procedure descriptions included in the prompt sentence in accordance with a result of the analysis.

16. The system according to claim 1, wherein the circuitry is configured to execute term conversion processing that converts technical terms in the character string data into generic expressions based on the user attribute information prior to generating the prompt sentence.

17. The system according to claim 1, wherein the context information comprises the user attribute information including at least a skill level, a language preference, and a task history of the user.

18. A system comprising:
circuitry configured to:
acquire, via a communication interface coupled to a packet-switched network, image data from an image capturing device, apply binarization processing, noise removal processing, and tilt correction processing to the image data, and execute optical character recognition processing on the processed image data to extract character information and convert the character information into machine-readable character string data;
execute natural language processing on the character string data comprising sentence segmentation, morphological analysis, syntactic analysis, semantic analysis, and sentence classification to classify each sentence into at least one of a procedure category, a warning category, a tool requirement category, and a note category, and generate structured data in which required components, required tools, and related warning information are assigned as attributes for each classified procedure;
generate a prompt sentence comprising constraint conditions that specify an output format, a detail level, and a display style, input the prompt sentence and the structured data to a generative information processing model, and generate procedure data in which each step includes a title, a description sentence, a warning sentence, and an operation template identifier;
associate each step with at least one operation template selected from a transport operation template, a fastening operation template, and an alignment operation template, and generate a low-level operation sequence comprising grasping operations, positioning operations, and fastening operations;
perform kinematic calculation and trajectory planning calculation on the low-level operation sequence to generate joint command values, position command values, and force command values in time order, and transmit the command values to an automated multi-joint work mechanism via the packet-switched network;
acquire position detection information, force detection information, and image detection information from the multi-joint work mechanism, correct parameters of the operation template in real time on the basis of deviations between the detection information and the command values, and stop the multi-joint work mechanism when a deviation exceeds a predetermined safety threshold; and
estimate an emotional state of a user based on at least one of facial expression image data, audio data, and operation history data, and change at least one of a motion speed, an acceleration, and a safety margin of the multi-joint work mechanism according to the estimated emotional state.

19. The system according to claim 18, wherein the circuitry is further configured to generate presentation data for transmission to a user terminal via the packet-switched network, the presentation data comprising visual step-by-step procedure data and audio guidance data, and to regenerate and update at least a part of the procedure data in response to a user request received from the user terminal.

20. A method performed by circuitry of a system, the method comprising:
acquiring, via a communication interface coupled to a packet-switched network, image data from an image capturing device, performing preprocessing on the image data, and executing optical character recognition processing on the preprocessed image data to extract character information and convert the character information into machine-readable character string data;
executing natural language processing on the character string data to segment the character string data into units of sentences and words, perform syntactic analysis and semantic analysis on the segmented data, and extract task procedure information, component information, and tool information, and generating structured data representing the extracted information;
generating a prompt sentence for input to a generative information processing model on the basis of the structured data and context information, executing the generative information processing model using the prompt sentence and the structured data as inputs, and generating procedure data in which a task procedure is represented as a sequence of steps; identifying steps executable by an automated multi-joint work mechanism, and generating a low-level operation sequence comprising grasping operations, positioning operations, and fastening operations;
performing kinematic calculation and trajectory planning calculation on the low-level operation sequence to generate joint command values, position command values, and force command values, and transmitting the command values to the multi-joint work mechanism via the packet-switched network; and
acquiring position detection information, force detection information, and image detection information from the multi-joint work mechanism, and generating correction commands on the basis of deviations between the detection information and the command values.
